SEQUENCE LISTING (44 sequences)

SEQ ID NO: 1 - DNA, 22 bp, Artificial sequence
  primer
caaggtcatccctgagctgaac

SEQ ID NO: 2 - DNA, 23 bp, Artificial sequence
  primer
tcgctgttgaagtcagaggagac

SEQ ID NO: 3 - DNA, 22 bp, Artificial sequence
  primer
caagttggctgatgagtcgctg

SEQ ID NO: 4 - DNA, 22 bp, Artificial sequence
  primer
tgatttggtccatcccttcctc

SEQ ID NO: 5 - DNA, 22 bp, Artificial sequence
  primer
aatgctgtatcaaatgcctggg

SEQ ID NO: 6 - DNA, 24 bp, Artificial sequence
  primer
gccatctcaaatgtaggtttgcag

SEQ ID NO: 7 - DNA, 23 bp, Artificial sequence
  primer
cctacaagaatgtggttggtgcc

SEQ ID NO: 8 - DNA, 24 bp, Artificial sequence
  primer
gcaaactgtctccagctccttctc

SEQ ID NO: 9 - DNA, 23 bp, Artificial sequence
  primer
ccatccaaagagtcttggtcagg

SEQ ID NO: 10 - DNA, 23 bp, Artificial sequence
  primer
gttgccagattgtcacagacgac

SEQ ID NO: 11 - DNA, 23 bp, Artificial sequence
  primer
tggctgaccaactgactgaagag

SEQ ID NO: 12 - DNA, 25 bp, Artificial sequence
  primer
gtaactctgcttctgtgggattctg

SEQ ID NO: 13 - DNA, 24 bp, Artificial sequence
  primer
ctcaaagggtacttccactgatgg

SEQ ID NO: 14 - DNA, 22 bp, Artificial sequence
  primer
caataggcagatttgggcaaac

SEQ ID NO: 15 - DNA, 20 bp, Artificial sequence
  primer
atgggcacgttgctcatcag

SEQ ID NO: 16 - DNA, 23 bp, Artificial sequence
  primer
tcgttgtcgatgcagtaggtctc

SEQ ID NO: 17 - DNA, 23 bp, Artificial sequence
  primer
tggtctgctctgtgagtggtttc

SEQ ID NO: 18 - DNA, 22 bp, Artificial sequence
  primer
tgtttccagcatcaccagggtc

SEQ ID NO: 19 - DNA, 20 bp, Artificial sequence
  primer
ccattaaggatgccaacgcc

SEQ ID NO: 20 - DNA, 24 bp, Artificial sequence
  primer
gacgttcatcagctcctggtactc

SEQ ID NO: 21 - DNA, 20 bp, Artificial sequence
  primer
gcaaatgcacctcctgcaag

SEQ ID NO: 22 - DNA, 22 bp, Artificial sequence
  primer
cgttctttacatctgggagcgg

SEQ ID NO: 23 - DNA, 22 bp, Artificial sequence
  primer
cattctgcacgacgatgaggtg

SEQ ID NO: 24 - DNA, 23 bp, Artificial sequence
  primer
cagatgaggctcccaatgttgac

SEQ ID NO: 25 - DNA, 22 bp, Artificial sequence
  primer
aaacctcgtggagaaaggaagg

SEQ ID NO: 26 - DNA, 25 bp, Artificial sequence
  primer
gcgtgtagtgatactgtgtgaccac

SEQ ID NO: 27 - DNA, 24 bp, Artificial sequence
  primer
tgtgaggacagacagaaggcaaag

SEQ ID NO: 28 - DNA, 24 bp, Artificial sequence
  primer
tgggctggaagagaccatgaagac

SEQ ID NO: 29 - DNA, 21 bp, Artificial sequence
  primer
gagttcccagaccgcatcatg

SEQ ID NO: 30 - DNA, 24 bp, Artificial sequence
  primer
gatgtcgtagagtgcctcgttgtc

SEQ ID NO: 31 - DNA, 20 bp, Artificial sequence
  primer
tgcagccttctcagccaaac

SEQ ID NO: 32 - DNA, 23 bp, Artificial sequence
  primer
ccacagcatctgggtatttgttg

SEQ ID NO: 33 - DNA, 23 bp, Artificial sequence
  primer
tgtgccaggactctctttcttcc

SEQ ID NO: 34 - DNA, 24 bp, Artificial sequence
  primer
aaggttcagtgtcccctgtgtcag

SEQ ID NO: 35 - DNA, 24 bp, Artificial sequence
  primer
tcaaggacgctgtgctctactctg

SEQ ID NO: 36 - DNA, 25 bp, Artificial sequence
  primer
ccaggaagtaaaggaagaaggtcac

SEQ ID NO: 37 - DNA, 20 bp, Artificial sequence
  primer
tcagggtgtttggcatgtcc

SEQ ID NO: 38 - DNA, 22 bp, Artificial sequence
  primer
tgtgggaggagatgaagaccac

SEQ ID NO: 39 - DNA, 23 bp, Artificial sequence
  primer
ccctcatcagagtcatggtttcc

SEQ ID NO: 40 - DNA, 23 bp, Artificial sequence
  primer
tcatcttctccacagagcagcag

SEQ ID NO: 41 - DNA, 20 bp, Artificial sequence
  primer
aattcggcatgagggaccac

SEQ ID NO: 42 - DNA, 21 bp, Artificial sequence
  primer
aatcttggcatcagggacacc

SEQ ID NO: 43 - DNA, 24 bp, Artificial sequence
  primer
cgctgaacaattacctgccaaatg

SEQ ID NO: 44 - DNA, 24 bp, Artificial sequence
  primer
cctagcagaagtcagttgtgttgg

(19) United States
(12) Patent Application Publication
(10) Pub. No.: US 2006/0235646 A1
(43) Pub. Date: Oct. 19, 2006

(54) Methods for eliminating false data from comparative data matrices and for quantifying data matrix quality

(75) Inventor: Hassan M. Fathallah-Shaykh, Chicago, IL (US)

Correspondence Address: FOLEY & LARDNER LLP, 150 EAST GILMAN STREET, P.O. BOX 1497, MADISON, WI, 53701-1497, US

(73) Assignee: Rush-Presbyterian-St. Luke's Medical Center

(21) Appl. No.: 10/633,875

(22) Filed: Aug. 4, 2003

Related U.S. Application Data
(60) Provisional application No. 60/400,911, filed on Aug. 2, 2002.

(51) Int. Cl. G06F 19/00

(52) U.S. Cl. 702/179

(57) ABSTRACT

This invention provides methods for eliminating false data from a comparative analysis of analytical data matrices, such as gene expression microarrays. The invention also provides methods for quantifying the quality of data provided by such comparative assays.

### CROSS-REFERENCES TO RELATED APPLICATIONS

This application claims priority to U.S. provisional patent application Ser. No. 60/400,911, filed Aug. 2, 2002, The entire disclosure of which is incorporated herein by reference and for all purposes.

### STATEMENT OF GOVERNMENT INTERESTS

This invention was made with United States government support under Grant Nos. R01-CA81367 and R29-CA78825 from the National Cancer Institute and the National Institutes of Health. The government of the United States has certain rights in the invention.

### FIELD OF THE INVENTION

This invention generally relates to methods for eliminating false data from a comparative analysis of analytical data matrices, such as gene microarray assays. The invention also relates to methods for quantifying the quality of data provided by such comparative assays.

### BACKGROUND OF THE INVENTION

A number of advances in medicine, molecular biology, and genetics have led to increased demand for technologies that quantitatively measure properties of biological samples. The positive results of various genome mapping projects, including the Human Genome Project, have made increased research into gene-related fields. Accordingly, systems and methods for conducting measurements of gene expression levels, the abundance of RNA for encoding specific genes, protein expression levels, and other gene-related properties of biological matter have been in great demand.

In recent years, comparative data matrices have been utilized to assay the differential expression of genes between different biological samples. One example of such comparative data matrices may be obtained using a protocol where labeled nucleic acid probe samples, derived from the RNA expressed in two different cell types, are hybridized to DNA from a large number of cloned genes that have been bound in a microscopic matrix on a durable support.

Such gene expression profiling has emerged as a robust tool for discovering genetic expression associated with a wide assortment of biological phenotypes, including human disease (Alter et al., 2000; Golub et al., 1999; Alizadeh et al., 2000; Bittner et al., 2001; Bittner et al., 2001; Golub et al., 1999; Alter et al., 2000; Fathallah-Shaykh et al., 2002). The term “microarray” is associated with the creation of a matrix of different biological samples bound in a predetermined pattern to a durable support, such as a glass or hydrocarbon polymer microscope slide. The microarray could be composed of a broad range of samples, including for biological applications, DNA, protein, antibodies, or families of organic compounds.

Unfortunately, genome-wide screening is still hampered by the preponderance of false positive data in the gene microarray experimental system. In genome-wide screening, the expression of only a small fraction of the genes is expected to differ between 2 biological samples; the expression of the predominant majority of the genes is expected to be unchanged. Because the number of genomic genes is in the tens of thousands, current analytical methods retain a large number of false positive data that exceed the number of genes expected to be truly differentially expressed. Such false positive data significantly impairs assessing which genes are significantly expressed in a cell, and what significant changes to such expression are occurring as cell conditions are varied.

One popular approach to circumventing the noise problems associated with gene expression studies has been to apply global normalization strategies to identify and eliminate noise. In conventional studies of this type composite samples pooled from groups of individual samples are compared to reference samples that are also pooled from groups of individual samples. In this approach large groups (often tens to hundreds or more) of samples are analyzed and conventional statistical analysis is employed. These statistical methods suffer from at least two significant drawbacks. First, they do not permit individual samples to be studied and compared, which defeats the idea that a genetic sample is molecularly unique. Second, statistical analysis does not entirely eliminate false data. For example, even if a 99% confidence interval is applied, 1% of the data still corresponds to noise and this data must be validated by other assays for molecular expression. Where the data set is large, even a 1% uncertainty produces a large number of data to be validated. Validation of the expression of genes is an expensive, time- and labor-consuming process, such that the validation of the expression of thousands of individual genes is not feasible for the typical laboratory. In addition, an experimental design that compares and contrasts different groups containing several genetically homogeneous samples is not always feasible. Thus, an experimental design that allows comparison of individual samples or samples made from a small number of individual samples, without the requirement for routine individual validation of results would have wide utility in the field of investigative biology.

Others have also recognized the limitations of global normalization strategies and have reported methods based on robust local regression (Yank et al., 2002). Baggerly et al. have derived models for the intensity of a replicated spot when replication is performed within and between arrays. They report that ratios computed from spots containing a small amount of total signal are highly variable, whereas ratios derived from spots containing large amount of total signal are fairly stable (Baggerly et al., 2001). Tusher et al. apply Significance Analysis of Microarrays to identify statistically significant changes in expression by assimilating a set of gene-specific t tests using oliogonucleotide arrays. They report a false discovery rate of 12%, an improvement from 60-84% by using conventional methods of analysis (Tusher et al., 2001). Unfortunately, these attempts have met with limited success in finding analytical methods to eliminate false data to a high degree of specificity.

Thus, a need exists for a method of direct expression profiling of two individual samples without the need for separate validation of the results.

Even when data obtained from two samples are compared directly, the quality of images produced from comparative hybridization of probe molecules to DNA matrices (e.g. DNA microarrays) are highly variable. It is expected that high quality images will yield a sharper separation between actual differences in expression and those differences due to systematic or random error. Increased sensitivity allows accurate identification of smaller differences in gene expression (higher sensitivity). Unfortunately, present methods for analyzing gene expression profiling experiments do not provide a quantitative method for assessing the quality of a given image relative to other images. Thus, a need exists for a method of quantifying the quality of data obtained from comparative data matrices.

### SUMMARY OF THE INVENTION

One aspect of the present invention provides a method for directly comparing data sets, or matrices, obtained from at least two individual samples, or at least two composite samples, each made from a small number of individual samples, using equations and filters to generate an algorithm that eliminates unreliable data from the data sets.

The data matrices to be analyzed by the present invention are composed of a plurality of data points assembled into a matrix, or array. These data points are obtained from measurements of measurable physical or chemical properties of the samples being studied. The measurable properties may be quantities or qualities and may include measurements of the structures, compositions, or dynamics of a sample. Thus, each data point within a data matrix corresponds to (i.e. provides information about) a particular property of a sample of interest.

The samples to be compared by the present invention give rise to the data matrices. Because the methods of the present invention are directed to a comparison between samples, at least two samples should be provided. In one embodiment, the samples are similar enough that the predominant majority of the measurable properties (i.e. the properties that are the subject of the comparative assays) of the samples are the same. Although the phrase “predominant majority” does not lend itself to a precise definition, in some cases, predominant majority may indicate 70%, 80%, 90% or even 95%. However, the methods described herein are effective at eliminating false data regardless of the degree of similarity between samples. Each sample should provide at least two replicate data matrices. In one embodiment of the invention, each sample provides four replicate data matrices. Replicate matrices are matrices that provide information about the same set of properties for each of the samples. As such, each data point in a matrix which provides information about a given property of the sample will have a data point in each of the other replicate matrices that corresponds to the same property. Such data points are referred to as replicate data points. It should be emphasized that replicate matrices are not necessarily identical matrices. Thus, while the data points in each matrix in a set of replicate matrices will have data points corresponding to the same measurable property in each of the other matrices in the set, these replicate data points may differ in quality or intensity.

Each of the replicate matrices for the first of the at least two samples has a corresponding matrix for the second of the at least two samples. Together these “symmetrical” matrices form a “matrix pair”. The term “symmetrical” is used to indicate that each data point in the first matrix of the pair has a corresponding data point in the second matrix of the pair. Moreover, each pair of corresponding data points in a given matrix pair will have a pair of corresponding data points in each of the other symmetrical matrix pairs in the study.

Each pair of corresponding data points within a matrix pair gives rise to a data ratio which is simply the ratio of the data for a given data point in the first matrix of the pair to the data for the corresponding data point in the second matrix of the pair. It follows that each data ratio for each pair of corresponding data points in a symmetrical matrix pair will have a corresponding data ratio for the corresponding pair of data points in each of the other symmetrical matrix pairs.

Systems to which the methods of the present invention may be applied are typically characterized by three sources of unreliable data points. The first source of unreliable data stems from data points that are indistinguishable from the random background noise level of the experimental system. The second source of unreliable data comes from data points that lie above the background noise level, but that are substantially indistinguishable from their corresponding data points in a symmetrical matrix. The remaining data points represent data points that lie above the background level and are distinguishable from their corresponding data points. However, not all of these remaining data points are reliable, some will inevitably be erroneous and irreproducible. Such data is classified as “false” data and gives rise to “false” differentials in a comparison between the data matrices. These false data typically result from experimental aberrations or artifacts that are either undetected or undetectable. These data points may be particularly misleading and may cause serious errors in data analysis if they are not identified and eliminated from the data matrices.

Because the nature of the systems being analyzed with the present methods may vary, the nature of the data provided by those systems will also vary. For example, the experimental data points generated from a gene expression profiling experiment may correspond to signal intensities generated from labelled cDNA sequences hybridized to complementary DNA sequences bound to a slide. One of skill in the art will recognize that the methods of the present invention may be applied to data derived from any system having the general characteristics outlined above, including but not limited to oligochip data, seismic data, chromatographic data, thermal gravimetric data, and economic data. In the description that follows, the invention is illustrated using data matrices obtained from gene expression profiling experiments as an exemplary embodiment. It should be emphasized, however, that this embodiment is used only for illustrative purposes and that the invention is not limited to data sets originating from such experiments.

Data derived from the systems described above may be displayed as an experimental curve by assigning the data points within each matrix a rank that corresponds to the magnitude, quantity, or quality of the data value for that data point. For the sake of simplicity, the phase “signal intensity” will be used to refer to the value of a given data point of any type. In the case where the background-subtracted intensity of a data point is less than zero, the data point may be assigned a small positive value. For example, the negative data points may be assigned values that are equal to or comparable to the value of the data point having the lowest positive value. For example, the data point in each matrix of a gene expression profiling study having the lowest signal intensity will be assigned a rank of “1” and the remaining data points will be assigned increasing ranks, in whole number increments, according to their signal intensity levels until the most intense data point is assigned a rank equivalent to the total number of data points in the matrix. Of course, other ranking notations, such as fractional increments may also be used.

The experimental curves are produced by plotting signal intensity (y-axis) versus rank (x-axis). These curves are generally characterized by three sections, although the sections may vary in length and overall level of intensity. The first section is an initial rising section. This section, which includes data points having signal intensities that are indistinguishable from the background noise in the system, is typically a relatively steep, non-linear rising section. The second section typically rises less steeply than the first and is more linear. Often this section will be relatively flat, making an angle of less than about 20° with respect to the x-axis of the plot. This section includes data points that lie above the background noise level, but that have signal intensities that are very similar to their neighboring data points on the curve and which may not be reliably distinguished from their corresponding data points in symmetrical matrices. The first and second sections are separated by an inflection point. The third section of the curve rises more steeply than the second section and may be exponentially increasing. The data points in this section are more easily distinguished from their neighboring points on the curve and from their corresponding data points in symmetrical matrices than are the data points in the second section. The three sections and the inflection point between the first and second sections may be more easily distinguished if the experimental curve is plotted on a log scale with respect to the y-axis (i.e. the intensity axis).

The methods of the present invention are particularly suited for analyzing and comparing data matrices derived from various biological samples. A biological sample may be a cell, cell line, cell culture, tissue sample, organ, fluid or excretion of a living thing, including both plants and animals or other biological system recognized to those of ordinary skill in the art. Further, a biological sample can be an extract or derivative of a biological sample including, but not limited to complementary or copy DNA (cDNA), messenger RNA (mRNA), genomic DNA (gDNA), DNA, RNA, genes, gene fragments, chromosomes, single nucleotide polymorphisms (SNPs), oligonucleotides, proteins or any combination thereof.

Typically, studies of the physical and chemical properties of biological systems will entail exposing the biological samples to an array of molecules with which the samples interact. This interaction may be in the form of a chemical reaction or a binding interaction or other similar interactions known to those of skill in the art. As used herein a binding interaction includes a covalent binding interaction, an electrostatic interaction, such as a hybridization, ionic binding or weaker interactions, such as hydrogen binding, or adsorption, or the like. The complementary molecules with which the samples interact may be referred to generally as indicator molecules.

As noted above the indicator molecules are laid in an array wherein each element of the array contains a single indicator molecule, or more likely, a small collection of said indicator molecule. Measurements of the signals produced by the interaction between the biological samples and the indicator molecules yield a data matrix that provides information about a variety of physical and chemical properties of the samples. As one of skill in the art will understand, the signal produced by the systems may take a variety of forms. For example, the signal may be in the form of emissions of radiation or light. The types of information that may be derived from comparative studies of biological systems include, but are not limited to, gene expression levels, protein expression levels, gene sequence variations, protein structure or conformation, ligand/receptor binding, nucleic acid/protein interactions, polymorphisms, and genomic gene duplication.

As noted above, one specific system to which the methods of the present invention may be applied is a gene expression profiling system which may also be referred to as a gene microarray assay. Most cells in an organism contain the same gene sequences. However, not all of these genes are used or expressed by the cells at all times. Some genes are expressed at specific times, in specific levels, at a specific developmental stage, or under specific conditions. Determining when a gene is expressed, therefore, helps provide an enhanced understanding of the effects of normal and variant genes on disease pathogenesis. In the microarray assays, the genetic expression profile of one biological sample is compared to the genetic expression profile of a second biological sample in order to identify individual genes whose expression is associated with any biological or pathological phenotypes.

In one type of gene expression analysis, the two biological samples comprise cDNA obtained from the reverse transcription of the RNA expressed by two different cell types or cell lines. In one exemplary embodiment, the first cell is a normal cell, such as a normal brain cell, and the second cell is an abnormal cell of the same general type, such as a meningioma cell. The data matrices in gene expression experiments are obtained from microarray slides having immobilized thereon a plurality (e.g. thousands) of different genes, or other DNA sequences, arrayed in a defined matrix or support. The cDNA samples are each labeled with a detectable label, such as a fluorescent label. The labeled cDNA can then be hybridized to the microarray slides by methods well known to those skilled in the art. Once hybridization is complete, the hybridization pattern of the labeled probes is detected using a suitable means of detection to produce an image comprising a series, or matrix, of “spots” wherein each spot has an background-subtracted intensity corresponding to the level of expression of a given gene on the microarray slide. These spot matrices are the data matrices to be analyzed by the present invention.

In this exemplary embodiment “corresponding data points” are spots in different images that correspond to the same gene on the microarray slides. The data matrix pairs are pairs of images wherein one image in each pair corresponds to the first sample and one image corresponds to the second sample. These are also referred to as symmetrical images. Similarly, “signal intensity ratios” are gene expression ratios and corresponding gene expression ratios (i.e. corresponding signal intensity ratios) are expression ratios for the same gene in different image pairs.

Another system to which the methods of the present invention may be applied is a protein expression profiling system which may also be referred to as a protein microarray assay. In protein microarray assays the protein expression profile of one biological sample is compared to the protein expression profile of a second biological sample. The two biological samples typically comprise protein obtained from two different cell types or cell lines. In one exemplary embodiment the first cell type is a normal cell, and the second cell type is an abnormal cell of the same general type, such as a carcinoma cell. The data matrices in protein expression experiments are obtained from microarray slides having immobilized thereon a plurality (e.g. thousands) of different antibodies, or other protein binding sequences, arrayed in a defined matrix upon a support. The protein samples are each labeled with a detectable label, such as a fluorescent label. The labeled proteins can then be allowed to specifically bind to the microarray slides by methods well known to those skilled in the art. Once binding is complete, the hybridization pattern of the labeled proteins is detected using a suitable means of detection to produce an image comprising a series, or matrix, of “spots” wherein each spot has an background-subtracted intensity corresponding to the level of expression of a given protein on the microarray slide. These spot matrices are the data matrices to be analyzed by the present invention. Those skilled in the art will recognize how protein matrices can be constructed to study DNA/protein interactions, ligand/receptor binding activity, or the interaction between a microarray of small molecules and a binding sample.

Another specific system to which the methods of the present invention may be applied is a nucleic acid sequence profiling system which may also be referred to as an oligonucleotide microarray assay (oligochip). In oligochip assays the nucleic acid sequence profile of one nucleic acid sample is compared to a duplicate nucleic acid sequence profile of the same nucleic acid sample. The nucleic acid samples typically comprise DNA segments for which the nucleic acid sequence is to be determined. The data matrices in nucleic acid sequence profiling experiments are obtained from microarray slides having immobilized thereon a plurality (e.g. thousands) of different short nucleic acids molecules of defined sequence (oligonucleotides), arrayed in a defined matrix upon a support. The nucleic acid sample is labeled with a detectable probe, such as a fluorescent probe. The labeled nucleic acid sample can then be hybridized to the oligochip slides by methods well known to those skilled in the art. Once hybridization is complete, the hybridization pattern of the labeled nucleic acid sample is detected using a suitable means of detection to produce an image comprising a series, or matrix, of “spots” wherein each spot has an background-subtracted intensity corresponding to the level of binding of a given oligonucleotide on the oligochip slide. These spot matrices are the data matrices to be analyzed by the present invention. By either labeling the nucleic acid sample with multiple probes which can be differentiated from one another, or by performing replicate hybridizations of the labeled nucleic acid sample to oligochips, comparative data can be obtained for analysis using the present invention. The intensity rations of the spots may provide information about oligonucleotide expression levels or polymorphisms. Those skilled in the art will recognize how oglionucleotide matrices can be constructed to study protein sequence or conformation.

One embodiment of the present invention provides a method for eliminating insufficiently distinguishable data points (e.g. false expression ratios) from a pair of the above-described data matrices. This method comprises the steps of, ranking the data points of each matrix from highest to lowest according to intensity and plotting the rank versus intensity of the data points for each matrix to generate an experimental curve for each matrix; fitting a smooth curve to each experimental curve to generate a model curve for each matrix, each model curve comprising a first section separated from a second section by an inflection point; eliminating any pair of corresponding data points for which each data point of the pair is below the inflection point of its model curve; and eliminating any pair of corresponding data points for which the rank of each data point of the pair is below a selected cutoff rank between the rank of the data point at the minimum of the derivative of one of the model curves and the rank of the highest ranking data point on the model curve. In this method, the selected cutoff rank provides a “distinguishability criterion” for determining which data points should be eliminated.

Although other methods may be used to select a suitable cutoff rank, the cutoff rank may desirably be determined as follows. An analytical rank is calculated for each model curve according to the equation:
f′(analytical rank)=C((f(rₘₐₓ)/rₘₐₓ)),
where f′(analytical rank) is the value of the first derivative of the model curve at the analytical rank, rₘₐₓ is the rank of a selected data point having a rank higher than CR, and f(rₘₐₓ) is the value of the model curve at rₘₐₓ. The cutoff rank may be selected to be the larger analytical rank of the two model curves. Generally, the higher the rank of CR, the more stringent the filter. Where some false data is acceptable, lower rₘₐₓ values may be used, but typically rₘₐₓ will be selected from the data points having a signal intensity in the upper 30% and desirably in the upper 20% or 10%. In one embodiment, rₘₐₓ is the rank of the highest ranking data point in the array.

The method may be extended to further eliminate false differentials from a comparison of two or more replicate data matrix pairs, of the type described above, by further including the steps of determining an intensity ratio for each remaining pair of corresponding data points in each matrix pair, wherein each ratio may be classified as less than, greater than, or substantially equal to one; and eliminating any corresponding pairs of corresponding data points for which the intensity ratios for the corresponding pairs fall into the same category for less than one half of the corresponding pairs.

Alternatively, the method may be extended to quantify the quality of a comparison between data matrix pairs, of the type described above, by further including the step of calculating a noise factor (NF) for the matrix pair according to the equation:

$$NF = \sqrt{\frac{{\sum }_{i = 1}^{n} {( {r}_{1 i} - {r}_{2 i} )}^{2}}{n}} * \frac{K}{( {r}_{max} - CR )} \qquad ( 1.0 )$$

wherein CR is the cutoff rank, n is the total number of remaining data points whose ranks are larger than the CR in both arrays, rₘₐₓ is the rank of a selected data point having a rank higher than CR, r₁ᵢ is the rank of data point i in the first data array of the pair, r₂ᵢ is the rank of the corresponding data point in the second data array of the pair, and K is a constant. If the noise factor is too large, the comparative data may be discarded and the experiment repeated until comparative data having an acceptable noise factor is obtained. Whether the noise factor is too large will depend on the nature of the experiment and on the acceptable level of false data.

One specific embodiment, which combines the elimination of indistinguishable differentials with the elimination of false differentials, may be carried out as follows. The method comprises the steps of, providing at least four replicate matrix pairs wherein each pair comprises a data matrix for a first sample and a data matrix for a second sample, each data matrix comprising a plurality of data points, each data point corresponding to a selected property of the samples, wherein each data point in a given matrix has a corresponding data point in the other matrices, such that corresponding data points provide information about the same property of the samples; identifying and eliminating any data points in the matrices that are indistinguishable from background noise; identifying and eliminating any remaining data points that are substantially indistinguishable from their corresponding data points in a symmetrical matrix, wherein data points are substantially indistinguishable if they fail to meet a predetermined distinguishability criterion; determining data ratios for corresponding data points in each pair of matrices, wherein the data ratio for two corresponding data points in each matrix pair has a corresponding data ratio in each of the other matrix pairs; and identifying and eliminating any remaining data points that provide intensity ratios that are substantially irreproducible, wherein intensity ratios are substantially irreproducible if they fail to meet a predetermined reproducibility criterion.

When the data matrices are generated from biological samples, the method for eliminating unreliable, or “false”, data from a data set may comprises the steps of, providing a first biological sample and a second biological sample, wherein each biological sample is labeled using at least one detectable label capable of emitting a signal having an intensity; providing at least two replicate arrays of indicator molecules; allowing the first and second biological samples to interact with the indicator molecules in the arrays; inducing the bound samples to emit a signal; measuring the resulting signal intensities to produce at least four data matrix pairs (e.g., by using a probe switching experiment), each matrix comprising a plurality of data points, each data point having an intensity corresponding to the level of interaction between the indicator molecules and the first and second biological samples, wherein each indicator molecule produces one data point in each of the data matrices and further wherein the data points produced by the same indicator molecules are referred to as corresponding data points; identifying and eliminating data points in each data matrix that have intensities below a background noise level; identifying and eliminating any remaining data points that are substantially indistinguishable from other data points in the same data matrix or from their corresponding data points in a matrix pair, wherein data points are substantially indistinguishable if they fail to meet a predetermined distinguishability criterion; determining intensity ratios for the corresponding data points in the at least four matrix pairs, wherein the intensity ratio for each pair of corresponding data points in each matrix pair has a corresponding signal intensity ratio in each of the other matrix pairs; and identifying and eliminating any remaining data points that provide intensity ratios that are substantially irreproducible, wherein intensity ratios are substantially irreproducible if they fail to meet a predetermined reproducibility criterion.

As noted above, a second aspect of the invention provides a method for quantifying the quality of a comparative data assay. One specific embodiment of this method comprises the steps of providing a first sample and a second sample; providing a replicate matrix pair comprising a data matrix for the first sample and a data matrix for the second sample, each data matrix comprising a plurality of data points, each data point providing a signal having an intensity, each signal corresponding to a selected property of the samples, wherein each data point in the first matrix of the pair has a corresponding data point in the other matrix of the pair, such that corresponding data points provide information about the same property of the samples; identifying and eliminating data points within each matrix having signal intensities below a background noise level; identifying and eliminating any remaining data points within each matrix having signals that are substantially indistinguishable from other signals in the same matrix or from their corresponding data points in a symmetrical matrix, wherein signals are substantially indistinguishable if they fail to meet a predetermined distinguishability criterion; ranking the remaining data points in the first matrix according to increasing signal intensity; ranking the remaining data points in the second matrix according to increasing signal intensity; and calculating a quality factor for the matrix pair according to the equation:

$$NF = \sqrt{\frac{{\sum }_{i = 1}^{n} {( {r}_{1 i} - {r}_{2 i} )}^{2}}{n}} * \frac{K}{( {r}_{max} - CR )}$$

wherein CR is the cutoff rank, n is the total number of remaining data points whose ranks are larger than the CR in both arrays, rₘₐₓ is the rank of a selected data point having a rank higher than CR, r₁ᵢ is the rank of data point n in the first matrix of the pair and r₂ᵢ is the rank of the corresponding data point in the second matrix of the pair. K is a constant they may be selected or calculated by the user. K may be determined empirically.

### BRIEF DESCRIPTION OF THE DRAWINGS

FIG. 1 illustrates curve fitting and normalization processes in accordance with the present invention.

FIG. 2 shows the linear correlation between the Noise Factor and standard deviation of data points lying above the cutoff rank.

FIG. 3 shows the corroboration of the results of Example 2 by (a) validation by real-time RT PCR which confirmed that all 21 measurements were in fact real data, and (b) by the expression of the genes in 10 other meningiomas using the 19K microarray chips.

FIG. 4 shows a linear correlation between serial dilution of starting total RNA and the threshold cycles as measured by one-step hot-start real time RT-PCR for G3PDH using SYBR green. The value of a threshold cycle is computed as the maximum of the second differential of a growth curve. The melting points range from 84.38 to 84.78.

FIG. 5. Representation of the expression data of 10 meningioma samples (columns) as compared to normal brain.

FIG. 6 shows how the discovery of differentially expressed genes may be used to predict activation of signaling pathways.

### DETAILED DESCRIPTION OF THE PREFERRED EMBODIMENTS

The present invention provides methods for reducing or eliminating false data in analytical assays of individual samples (or composite samples made from a small number of individual samples), particularly biological samples. In addition, the present invention provides methods for quantifying the quality of assays provided by individual samples or small composite samples. In some embodiments, small composite samples are made from 100 individual samples or less, or even 10 individual samples or less. A first aspect of the invention provides an algorithm for eliminating false data from an assay using one or more filters. The first filter removes data that is indistinguishable from background noise; the second removes data that is insufficiently distinguishable from other data; the third filter removes irreproducible data, and a fourth removes anomalous false data. The four filters may be applied sequentially. A second aspect of the invention provides a quantitative measure of the quality of a given comparison between assays.

The present invention is illustrated and exemplified using a gene microarray assay to analyze cDNAs in normal human brain cells and meningiomas. However, as will be understood by one of ordinary skill in the art, the present invention is susceptible to embodiment in various forms and the teachings of the present invention can be applied to other analytical assays that are subject to false positive results or other forms of noise.

Gene microarray assays are used to study genetic expression profiling. The assays are performed using microarray chips or slides containing cDNAs or controls (here referred to as “genes”) laid in a patterned array. Typically, the cDNAs are laid in duplicate on a slide in order to provide an additional set of expression data for each gene. Such microarray slides are well known to those in the art and are available commercially. The samples used in a gene microarray assay are prepared by extracting the RNA from a cell and reverse transcribing the RNA to obtain cDNA which is then labeled using a detectable label, or “probe”. In a preferred embodiment, each sample will be labeled with a different label. Examples of detectable labels include, but are not limited to, radioactive labels, fluorescent labels, coloremetric, and fluorometric labels. Methods for producing labeled cDNAs from cell samples are well known in the art. Once the labeled probe samples have been prepared, they are hybridized with the genes on the microarray where they emit a detectable signal characterized by a signal intensity. In some embodiments, for example where the labels are fluorescent labels, the probe samples will need to be induced to emit a signal. In the case of fluorescent probes, this is accomplished by illuminating the samples with light of an appropriate wavelength. The signal is captured to form an image of spots having varying signal intensities, wherein the background-subtracted intensity level of a given spot corresponds to the level of expression of the gene that corresponds to that spot. The background that is subtracted from the spot intensity is typically measured from the background (or dark areas) of the image surrounding the spot.

In the protocol described above, each slide produces a pair of symmetrical images which are superimposed on each other (i.e., data matrices) where the term “symmetrical” refers to the two images produced from the two different labels. The symmetrical images provide the data matrix pairs that are to be compared. In addition, because each of the genes is laid in duplicate, each slide yields two replicate data arrays for each sample. Therefore, each slide gives rise to a total of four data arrays, two for each sample.

The four data arrays are obtained by conducting “reverse experiments.” Reverse experiments are probe switching experiments where the labels are switched between the two samples to be compared and the experiment is repeated as described above. While reverse experiments are not required, they are performed to annul confounding variables introduced by heterogeneous fluorescence of the labels.

The specific gene expression profiling system described herein used a 1.7 K microarray chip of genes (i.e. a chip containing 2×1740 genes=3480 genes) obtained commercially from the Ontario Cancer Institute. The samples are normal human brain tissue and meningiomas. The samples were labeled with the fluorescent labels Cy3 and Cy5 and hybridized to the genes on the slide. Images were obtained by inducing the labels to fluoresce by illuminating them within laser light of a suitable wavelength and imaging the fluorescence signals to produce a matrix of spots. Two measurements were made from each spot: 1) total intensity within the spot; and 2) local background intensity within a small rim surrounding the spot. Background-substrated intensities were calculated by subtracting the background measurements from the total intensity measurements.

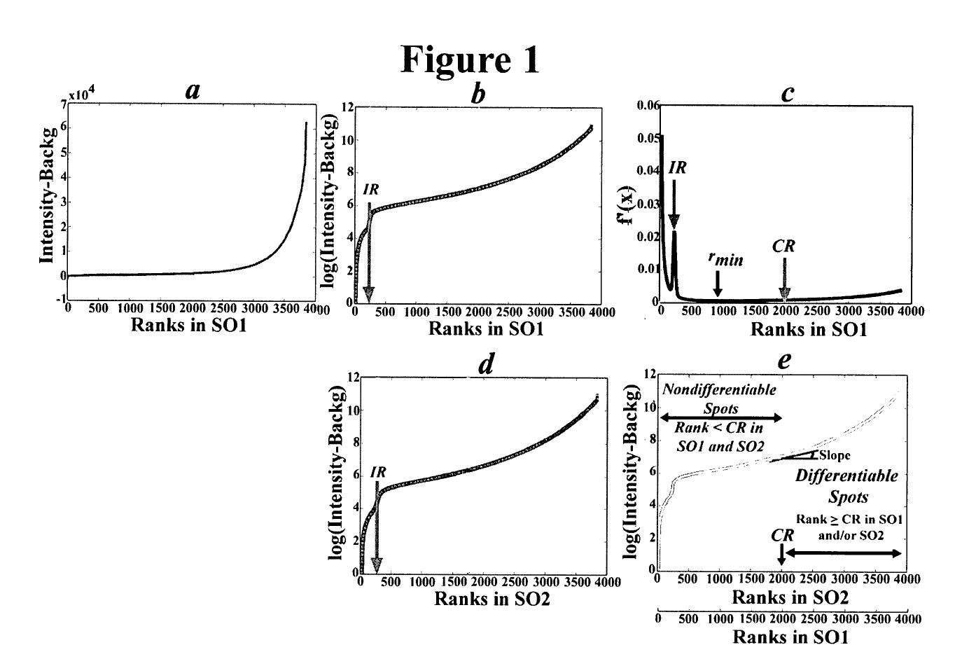

As discussed above, the dynamic range of the spot intensities will have a characteristic pattern. To model the dynamic range of the spots in each matrix, background-subtracted spot intensities were sorted in ascending order (x-axis) and plotted as a function of intensity (y-axis) to generate a ranking curve I(x) as shown in FIG. 1a. The x-axis of FIG. 1a is a listing of spots ranked in ascending order by their background-subtracted intensities; the x-axis coordinate corresponding to a specific spot is defined as its Rank. For instance, a spot whose rank is 3000 has a higher background-subtracted spot intensity than all spots whose ranks are less than 3000. A microarray Spot Order (SO) is a listing of the spots in an array sorted by their ranks.

FIG. 1b is a plot of the log transformation of the data in FIG. 1a (dashed line); it reveals an experimental curve L(x) having 3 sections: 1) an initial segment where spot intensities rise rapidly, 2) a second almost “linear” section associated with small incremental changes in intensity, and 3) an “exponentially-growing” section. Each of the spot matrices will give rise to a curve having the same general shape as that shown in FIG. 1b, although the lengths of each section and the overall intensity of the curves may vary from curve to curve. This set of curves is referred to as a family of curves. A smooth model curve, referred to as a dynamic range equation, f(x), may be drawn through the data points in such a way that the points are as close to the curve as possible. An exact fit is unlikely due to chance fluctuations owing to experimental variability or errors in measurements. By eliminating these fluctuations true inflection points and other slope changes in the curve become more easily discernable—the value of which will become apparent later in this discussion. The equation used to model the shape and curvatures of the data shown in FIG. 1b, was deduced by the inventor. This equation is shown below as equation 1.1 which models the L(x) family:

$$\begin{matrix}f ( x ) = ( \frac{{a}_{1}^{*}}{x + {a}_{2}} + \frac{x}{{r}_{max} - x + {a}_{3}} - {a}_{4} ) * {a}_{5} * \\ ( \frac{1}{1 + {( \frac{{a}_{7}}{x} )}^{{a}_{6}}} + \frac{{a}_{g}}{1 + {( \frac{{a}_{10}}{x} )}^{{a}_{9}}} - \frac{{a}_{11}}{x + {a}_{12}} ) * \\ ( 1 + \frac{ {a}_{ 13}}{ 1 + {\vert 1 - \frac{ {a}_{ 15}}{ x} \vert}^{{a}_{14}}} ) + ( \frac{1}{1 + {( \frac{{a}_{17}}{x} )}^{{a}_{16}}} - {a}_{18} ) * {a}_{19}\end{matrix} \qquad ( 1.1 )$$

where x and f(x) refer to the rank and log (background-subtracted intensity), respectively, for each data point, (a₁, . . . , a₁₉) are variables that vary between individual curves and rₘₐₓ is desirably equal to rank of a data point having a signal intensity in the upper 30%, 20% or 10% of the data points, and is preferably equal to the total number of data points (spots) in the matrix (image). The dark solid line shows the plot of example 1.1 that best fits the experimental curve (dashed line). One of skill in the art will recognize that other equations, polynomials, or statistical approximations may be used to fit the experimental data generated by an analytical assay of the type described herein. Although, example 1.1 is particularly useful, the present invention is not intended to be limited to methods that use example 1.1 to model the experimental data.

Equation 1.1 has been demonstrated to fit a broad range of gene expression microarray data. For example, microarray expression data was obtained using 1) a 1.7K microarray slide of human cDNA, 2) a 19K microarray slide (38,400 spots on 2 separate slides) of human cDNA, 3) a 15K microarray slide 15K (31,200 spots on 1 slide) of mouse cDNA, and 4) all 266 curves from the lymphoma study by Alizadeh et al., Nature, 406, 536-539 (2001). Fitting equation 1.1 to the data of the microarrays discussed above yield R-square values>0.99. More importantly, because the smooth curves of equation 1.1 lack the fluctuations of biological data, mathematical principles may be applied to: 1) understand the behavior and distribution of false data, 2) find parameters that measure quality, and 3) find filters that extract true differentials from the direct comparison of 2 samples.

Fitting the sorted data for each symmetrical image into equation 1.1 generates 2 intensity curves I₁, and I₂, 2 log functions L₁, and L₂, 2 dynamic range equations f₁, and f₂, and 2 separate Spot Orders, (SO1 and SO2), where the subscript 1 indicates sample 1 and the subscript 2 indicates sample 2. Each spot can thus be represented by its 2 ranks (r₁(s), r₂(s)) in SO1 and SO2, respectively.

Due to a variety of experimental factors, the data arrays, as represented by the fitted curves of equation 1.1, will vary in their overall intensity levels. Examples of experimental factors that may affect signal intensities from one experiment to another include, but are not limited to, differences in reaction conditions, probe quality, probe specificity, laser variations, scanner variations, spectrometer/system drift, temperature changes, sample insertion and alignment effects, purge changes, alignment changes, detector changes and nonlinearities, source changes, and changes in other components. For this reason it is advisable to normalize the data in the various data matrices prior to making any comparisons between matrices to annul confounding experimental variations in labeling, laser and probe intensities.

While a variety of normalization techniques may be used, the inventor has discovered a unique normalization technique based on the idea that the product of the expression ratios of the predominant majority of spots equal one and, therefore, the product of all the expression levels in one sample is equal to the product of all the expression levels in the other sample; thus:

$$\begin{matrix}{\prod }_{s = 1}^{3840} ( \frac{{ⅇ}^{{L}_{1} ( {r}_{1} ( s ) )}}{{ⅇ}^{{L}_{2} ( {r}_{2} ( s ) )}} ) = 1 \\ Formula ( 2.1 ) leads to \text{:} & ( 2.1 ) \\ \frac{{\prod }_{p = 1}^{3840} {ⅇ}^{{L}_{1} ( p )}}{{\prod }_{p = 1}^{3840} {ⅇ}^{{L}_{2} ( p )}} = 1 , \\ and \\ {\sum }_{p = 1}^{3840} ( {L}_{1} ( p ) - {L}_{2} ( p ) ) = 0 & ( 2.2 )\end{matrix}$$

where p denotes the same rank in SO1 and SO2. Equation 2.2 uncovers a new strategy for normalization. Specifically, the y-coordinates of the ranks of SO2 are transformed to become equal to the y-coordinates of equal ranks in SO1. For instance, to normalize the expression data of SO2 to model the log curve L₁, a normalization function N is applied to the data of SO2 such that:
N(p)=I₁(p) and normalized L₂(p)=log(N(p))=L₁(p) (2.3)
where p denotes the same rank in SO1 and SO2.

FIGS. 1e and d illustrate the normalization process. FIG. 1d shows the experimental curve (dashed line) for the symmetrical image for the data shown in FIGS. 1a-c, and the plot of equation 1.1 (dark solid line) that best fits the experimental data. FIG. 1e shows the curve of FIG. 1d after normalization according to equation 2.2. Here, the y-coordinates of the ranks of the data for the second sample are transformed to be equal to the y-coordinates of equal ranks of the data for the first sample. The darker arrow points to the inflection rank, rₘᵢₙ refers to the rank where the curve of the derivative reaches a minimum, and the lighter arrow points to the cutoff rank. In order to avoid the introduction of false data into the analysis the “first” sample (i.e. the sample denoted with the number one in the above discussion) should be sample that provides the noisier data. This will ensure that the coordinates of the less noisy data are transformed to match those of the noisier data. Thus, a single normalized curve models both symmetrical data sets, but the specific ranking of the spots differs between symmetrical Spot Orders (SO1 and SO2, FIG. 1); for instance, the spot whose rank is 3000 in SO1 may be different than the spot whose rank is 3000 in SO2. Alternatively stated, a given spot may have different symmetrical ranks in SO1 and SO2. The normalized genetic expression ratio of a spot is computed as:
(normalized intensity of its rank in SO2)/(normalized intensity of its rank in SO1).
Thus, if g(x) is the dynamic range equation for the normalized data, then the normalized expression ratio of a spot whose ranks are xₐ and x_{b} in SO1 and SO2, respectively is:
normalized ratio=e^{g(x}^{ₐ}^{)-g(x}^{_{b}}⁾

The first filter employed in the method of the present invention removes data points that represent or are indistinguishable from random or systematic background noise from the data matrices. In the curves of FIGS. 1b, d, and e, these data points will be found predominantly in the first segment of the curve. This first segment of the L(x) family of curves rises rapidly; the rate of increase is maximum at the point of inflection that corresponds to the maximum of f′(x) (i.e., the derivative of f(x)) in that segment (FIG. 1c). The full equation for f(x) is provided in the Equations section below. The rank (x-coordinate) of the point of inflection is defined as the Inflection Rank.

The gene expression microarray used to exemplify the present invention included 256 spots containing no cDNA. In this system it was observed that the y-coordinate at the Inflection Rank corresponds to a small background-subtracted intensity, ranging from 50-150, most probably generated by non-specific probe binding. Not surprisingly, the Inflection Rank for the curve lies close to 256, as shown in FIG. 1b. From this data, it can be concluded that the predominant majority of the genetic measurements whose symmetrical ranks are smaller than the Inflection Rank are expected to be false and should be removed from the data matrices. In this manner the Inflection Rank provides the first filter for false data.

The second filter is used to remove data points from the data matrices that are substantially indistinguishable from other data points in the same matrix or from their corresponding data points in a symmetrical matrix. In the family of model curves produced by equation 1.1 the “distinguishability” of a given point on a curve is determined with respect to the consecutively ranked data points lying on either side of that point. A data point is considered substantially indistinguishable from another data point if it fails to meet a predetermined “distinguishability” criterion. As used herein, the term predetermined criterion merely refers to a criterion that is chosen or calculated by a user. One of skill in the art will recognize that the distinguishability criterion may be determined or selected based on a wide variety of factors and preferences, including the permissible level of false data in a comparative data set. For example, the distinguishability criterion may correspond to a minimum angle formed between consecutive points along the second section of a model curve and the x-axis of the plot. Alternatively, the distinguishability criterion may correspond to a minimum detectable fractional intensity change between consecutively ranked data points on a model curve. Again, the threshold for the minimum detectable fractional intensity change may be chosen according to a variety of factors, including the permissible level of false data in a comparative data set. A simple and straightforward means for measuring the intensity change along a model curve is to take the derivative of the curve.

FIG. 1c plots a curve of the derivative of equation 1.1 which is denoted by f′(x) (Equation 1.2, below). Thus, the equation of the family of curves in FIG. 1a and its differential equation are:
h(x)=e^{f(x)} (1.3)
and h′(x)=f′(x)*e^{f(x)} (1.4),
respectively.

After reaching the inflection point, the curve of f′(x) decreases to a minimum corresponding to a rank, rₘᵢₙ, then increases continuously (FIG. 1c). In the example shown in FIG. 1c, the value of f′(rₘᵢₙ) is very close to 0. In order to set up the second filter, the minimum rank within the interval [rₘᵢₙ, rₘₐₓ] that allows the differentiation of consecutively ranked data points should be determined. To this end an Analytical Rank (AR) ε[rₘᵢₙ, rₘₐₓ] may be defined such that:

$${f}^{′} ( AR ) = C * \frac{f ( {r}_{max} )}{{r}_{max}} \qquad ( 3.3 )$$

where C is a constant that may be determined by the user taking into consideration such factors as the permissibility of false data in the comparative data set. The AR typically maps close to the junction between the linear and exponentially growing parts of the curves of f(x) (FIGS. 1b and 1c, arrows). In one embodiment of the invention, the constant C is determined empirically by applying the completed algorithm of the present invention (the description of which continues below) to a set of data matrices and varying the value of C to determine which value extracts the largest number of true data points from the data matrices. For the exemplary gene expression system described herein the value of C that extracts the largest number of true expression ratios lies between about 0.3 and 0.4 and preferably between 0.35 and 0.37. The optimum value for C for the system is 0.36. However, one of skill in the art will recognize that a suboptimal value of C may be selected by the user where it is not important to eliminate all false data from the data matrices.

Each of the curves in the family of curves may have a slightly different AR. However, for the sake of consistency, a single rank should be chosen as the second filter for all of the data matrices. This single rank is called the Cutoff Rank. In one embodiment the Cutoff Rank is the largest AR of all the data matrices (i.e. all the spot images), and substantially indistinguishable data points (spots) are those data points whose ranks in both Spot Orders are smaller than the Cutoff Rank. These substantially indistinguishable data points are excluded from further analysis. This filter may exclude spots by transforming their expression ratios to 1. One of skill in the art will recognize that the Cutoff Rank may be some other function of the ARs for the matrices. For example, the Cutoff Rank may be the average AR of all the data matrices. However, it should be noted that a Cutoff Rank that is lower than the largest AR of all the data matrices will not be as effective at eliminating false data.

Optionally, data points having abnormally high or low background levels may also be removed from the data matrices at this stage. For example a spot may be eliminated from the analysis if its background lies outside the mean+/−c * (standard deviation of all background measurements), where c is a constant that represents some selected number of standard deviations. In various embodiments c is at least two. In other embodiments, c is at least three. This rule may be added to the first filter in conjunction with the inflection point to eliminate data that is indistinguishable from background noise.

The third filter to be applied to the data matrices of the present invention is directed to removing aberrant “false positive” data where false positive data is data that indicates a difference in the physical or chemical properties of the two samples in a comparative analysis where no real difference exists. This filter operates by identifying and eliminating data points that produce signal intensity ratios that are substantially irreproducible. Substantially irreproducible data points refers to data points that fail to meet a predetermined reproducibility criterion. As before, a predetermined criterion merely refers to a criterion that has been chosen or calculated by a user.

If a difference in signal intensity for a data point that measures a given physical or chemical property in two samples is real, the measured difference should be reproducible in multiple tests. In the systems studied by the present invention the difference in signal intensity is measured by the signal intensity ratio. In the specific example of gene microarray studies, the signal intensity ratio is also known as the gene expression ratio. Therefore, one would expect to obtain roughly the same gene expression ratio for each of the four spot images (i.e. matrix pairs) produced by the gene expression studies. Of course, small differences in experimental conditions may lead to some variation in the expression ratios for different pairs of images. However, at a minimum one would expect the expression ratios to be qualitatively the same, that is, to deviate from 1 by being consistently greater than 1 or consistently less than 1. In the context of this disclosure a signal intensity ratio that is greater than 1 (or, alternatively, a signal intensity ratio that has a positive log2 value) is said to be “up regulated,” while a signal intensity ratio that is less than 1 (or, alternatively, a signal intensity ratio that has a negative log2 value) is said to be “down regulated.”

In one embodiment of the invention the reproducibility criterion, the third filter requires that the majority of the corresponding signal intensity ratios have the same sign (i.e., consistently showing either up or down regulation). It follows that in the reverse experiments described above, this reproducibility criterion would require either three or four of the four gene expression ratios for a given gene to be of the same sign. Requiring four out of four give expression ratios to be of the same sign will effectively eliminate any false data from the gene microarray assay (see Example below). However, if a higher level of false data is acceptable, a reproducibility of only 3 out of four or 2 out of four may be sufficient. Alternatively, the reproducibility criterion may require that at least half of the corresponding signal intensity ratios have the same sign. This includes embodiments where the reproducibility criterion requires a reproducibility of about 60%, about 70%, about 75%, about 80%, about 90%, or even about 95%. The number of replicate spots that are selected to meet the reproducibility criterion of consistently showing either up or downregulation will be referred to as “rc.” Again, this filter may eliminate spots by transforming their expression ratios to 1.

For a more stringent analysis, the data points may be analyzed for quantitative as well as qualitative reproducibility. The purpose of such an analysis is to identify and eliminate data points that yield log2(signal intensity ratios) that consistently have the same sign but vary considerably with respect to their absolute values. For example, one could apply a final filter to eliminate data points that lie outside the largest standard deviation of all remaining log2(ratios) multiplied by a constant, z. The constant z may vary over a broad range, however, it should be noted that as the constant decreases the filter becomes less discerning, allowing more false data to slip through. In various embodiments the constant is one, two, three, or four.

It should be emphasized that the algorithm outlined above may be modified in a number of ways to make the various filters more or less stringent without deviating from the subject matter encompassed by the present invention. A filter that is too stringent may eliminate real data points, while a filter that is not stringent enough may allow false data points to pass through. For example, each of the constants (c in filter one, C in filter two, rc in filter three, and z in filter four) may be tuned to increase or decrease the sensitivity of their respective filters. Similarly, both the distinguishability and reproducibility criterion may be selected and designed to be more or less discerning. In addition, although the specific system discussed herein provided four signal intensity ratios (i.e. expression ratios) for each sample, systems may be employed that provide only two data matrices for each sample, and, therefore, only two signal intensity ratios. The nature of the system being studied and the needs of the user should determine how much false data is permissible in a given analytical assay, which in turn will dictate the chosen sensitivity of the filter.

A second aspect of the invention provides a quantitative measure of the quality of a comparative set of data matrices. The idea behind this aspect of the invention is that the degree of noise or false data may vary amongst replicate data matrices due to experimental inconsistencies even when the matrices correspond to the same sample. One way to assess the level of false data in a comparison between two data matrices relative to other matrices is to visually inspect the noise level in the data. Unfortunately, where a large number of data sets are involved visual inspection may not be practical or sufficiently accurate. Therefore it would be helpful to the experimentalist to have some quantitative measure of the sensitivity and reliability of a given data comparison.

One way of illustrating the level of false data in a comparison between two data matrices is to rank the data points in each matrix by increasing signal intensity and to plot the ranks of the data points in the first matrix (x-axis) against the ranks of the corresponding data points in the second matrix (y-axis). In a system where the predominant majority of corresponding data points are expected to be the same, the resulting plot should produce a straight line at y=x. Therefore, the degree of divergence about the line y=x provides a measure of the noise in the system.

The present invention provides a method for quantifying the degree of divergence by calculating a “noise factor” (NF) using equation 1.0 below.

$$NF = \sqrt{\frac{{\sum }_{i = 1}^{n} {( {r}_{1 i} - {r}_{2 i} )}^{2}}{n}} * \frac{K}{( {r}_{max} - CR )} \qquad ( 1.0 )$$

where n is the total number of remaining data points in each matrix, rₘₐₓ is defined as above, r₁ᵢ is the rank of data point n in the first matrix of the pair, r₂ᵢ is the rank of the corresponding data point in the second matrix of the pair, and K is a constant. In one embodiment, K is ten.

For the purpose of illustrating and exemplifying the usefulness of the noise factor, an exemplary embodiment using the above-described gene microarray assay is described below. In this system, the data points corresponding to the background noise of the system (i.e. the points lying below the inflection point on the model curve of FIG. 1b) have already been eliminated from the analysis.

The notion that overall expression does not differ between 2 samples in a gene microarray assay stipulates that the ranks of the predominant majority of spots in symmetrical Spot Orders are similar. This idea should be especially true in this design where the symmetrical images contain identical genetic information.

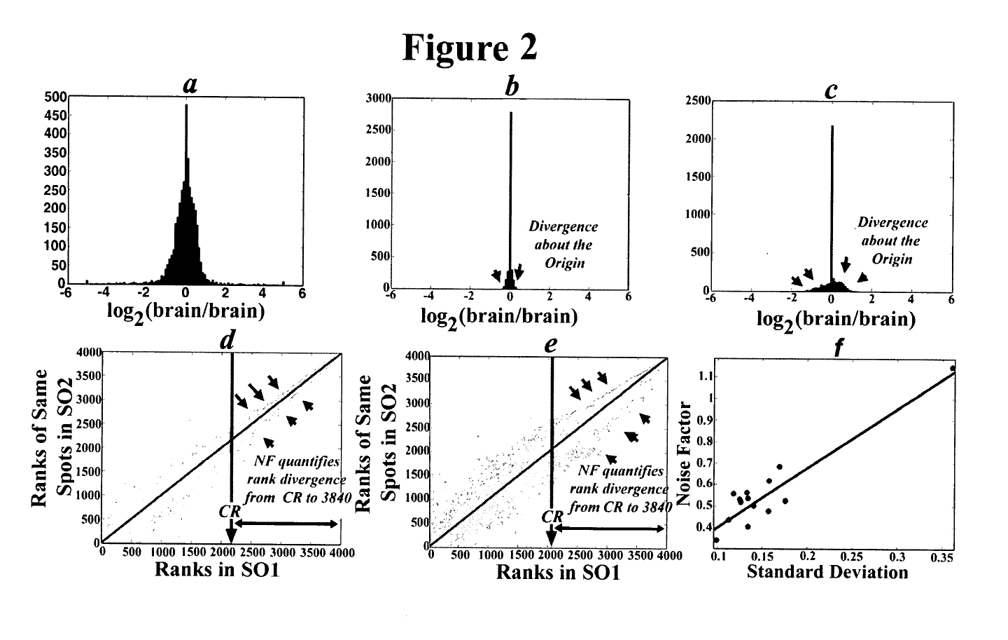

FIG. 2 demonstrates the linear correlation between the noise factor and the standard derivation of the data points lying above the cutoff rank. To study rank variability, spots were plotted by their ranks in SO1 (x-axis) and SO2 (y-axis); as anticipated, the data scatter about the line y=x. FIG. 2a shows a histogram of the unfiltered log 2 transformed normalized ratios for the above-described 1.7K microchip assay. FIGS. 2b and c show the histograms from 2 different samples including those data points that were not eliminated as indistinguishable from the background noise or from their corresponding data points. (R-square>0.9; FIG. 2b) The data in FIGS. 2a and 2c correspond to the same data set. The degree of divergence from y=x varies amongst these replicate sets of symmetrical images despite the fact that in this case they correspond to the same RNA pool (normal brain RNA; FIGS. 2b and 2c). The standard deviations of the data in 2b and 2c are 0.1 and 0.36, respectively.

FIGS. 2d and 2e show the scatter plots of the symmetrical ranks of the experiments shown in FIGS. 2b and 2c, respectively. Arrows transect the x-axis at the Cutoff Rank. As shown in FIGS. 2d and 2e, the degree of divergence (small arrows) about y=x differs between (d) and (e). The results suggest a relationship between the divergence of the noise about the origin (indicated in FIGS. 2b and 2c with arrows) and the divergence of symmetrical ranks about the line y=x (indicated in Figs. d and e with arrows).

The noise factor quantifies the degree of divergence of the ranks in symmetrical Spot Orders about the segment of y=x that extends from the Cutoff Rank to rₘₐₓ (FIGS. 2b and 2c). FIG. 2f reveals a linear correlation between the noise factor (as calculated by equation 1.0) with K=10, rₘₐₓ=3840 and C=0.36, and the standard deviations of the noise. The findings identify the NF as a quality parameter that determines the sensitivity. Because small NF generate noise distributions with small variance about the origin; one could potentially distinguish true from false and filter the noise without sacrificing true but small variations in gene expression.

### EXAMPLES

### Example 1

### Demonstration of the Algorithm Using Internal Control

In order to assess the specificity of the algorithm of the present invention, ten probe switching (reverse) experiments comparing normal brain RNA to itself using a 19K microchip and nine experiments using a 1.7K microchip were performed to yield images of heterogeneous quality.

Methods:

Samples and Microarrays. Normal brain RNA is obtained by pooling RNA from human occipital lobes harvested and pooled from 4 individuals with no known neurological disease whose brains are frozen less than 3 hours postmortem. The quality of RNA is assayed by gel electrophoresis; only high quality RNA is processed. Total RNA (5-10 μg) is reverse transcribed and the cDNA products labeled by the amino-allyl method and hybridized to the 19K and 1.7K gene microarrays purchased from the Ontario Cancer Institute (Toronto, CA). The slides are scanned at 10 μm by a confocal scanner, (4000XL scanner, Packard Bioscience; Meriden, Conn.). Images are quantified by the Imagene Software (Biodiscovery; Los Angeles, Calif.).

Algorithm:

The filtering algorithm described above was employed to eliminate false data from the images. The variables used in the algorithm are as follows: 1) C=0.36; 2) c=2, 3) rc=4, and 4) z=3. The value of C was determined empirically by applying the completed algorithm and varying the value of C to find the value that extracted the largest number of real data points from the data matrices. The algorithm was run with a reproducibility criterion requiring three of the four gene expression ratios for each gene to be of the same sign, and again with a reproducibility criterion requiring four of the four gene expression ratios for each gene to be of the same sign (rc=4).

Results:

Of all nine reverse experiments, only 1 of the total of 17,280 (i.e. 9×1 920) genes was not filtered after application of the algorithm. Changing the reproducibility criterion to require 3, rather than 4, of the 4 gene expression ratios to be of the same sign resulted in an 8-fold increase in the number of false positives genes. The complete algorithm was then applied to the data of the ten reverse experiments using the 19K microchip (i.e. two slides, 9600 genes/slide; total=19,200 genes) where both symmetrical images correspond to the same RNA. Only one of the 19,200 genes is resistant to filtering. The results correlate to false data levels of less than 0.01% and less than 0.001%, respectively. These results, which are shown in Table 1, demonstrate the effectiveness of the algorithm in filtering noise.

### Example 2

### Demonstration of the Algorithm on a Comparative System I

As a proof of principle, the complete algorithm discussed above is applied to the data of a reverse experiment comparing human meningioma RNA to normal human brain using the 1.7K microarray chip. 21 genes were extracted as sources of real data. The data was validated using real time PCR and by expression profiling of other meningioma samples. The references cited in the results section below are listed at the end of the example.

Methods:

Samples and Microarrays. The microarrays were prepared, scanned, and quantified by the methods described in Example 1 above. The meningioma samples were obtained from surgical operations, frozen and stored in liquid nitrogen until the time of use. Total RNA was extracted and transcribed to cDNA which in turn was reacted with the fluorescent probe by the aminoallyl method. Normal brain RNA was pooled from 4 individuals with no known neurological disease whose brains are frozen less than 3 hours postmortem. Normal Brain RNA was transcribed to cDNA and reacted with dye using the same protocol as was used for the tumor RNA. The quality of normal brain RNA and tumor RNA was determined by gel electrophoresis; only high quality samples were processed.

RT PCR. Total RNA samples are analyzed by one-step hot-start real-time RT-PCR (Qiagen, Valencia, Calif.; Cepheid, Sunnyvale, Calif.). Primer pairs are generated for each of the 21 genes as well as G3PDH. The sequences for each of the pairs and G3PDH were as follows:

| | |
|---|---|
| G3PDH | |
| Forward primer: | |
| 5′-CAAGGTCATCCCTGAGCTGAAC-3′ | (SEQ. ID NO.: 1) |
| Reverse primer: | |
| 5′-TCGCTGTTGAAGTCAGAGGAGAC-3′ | (SEQ. ID NO.: 2) |
| Annealing Temperature: 60° C. | |
| SN25 | |
| Forward primer: | |
| 5′-CAAGTTGGCTGATGAGTCGCTG-3′ | (SEQ. ID NO.: 3) |
| Reverse primer: | |
| 5′-TGATTTGGTCCATCCCTTCCTC-3′ | (SEQ. ID NO.: 4) |
| Annealing Temperature: 60° C. | |
| M6A | |
| Forward primer: | |
| 5′-AATGCTGTATCAAATGCCTGGG-3′ | (SEQ. ID NO.: 5) |
| Reverse primer: | |
| 5′-GCCATCTCAAATGTAGGTTTGCAG-3′ | (SEQ. ID NO.: 6) |
| Annealing Temperature: 60° C. | |
| 143F | |
| Forward primer: | |
| 5′-CCTACAAGAATGTGGTTGGTGCC-3′ | (SEQ. ID NO.: 7) |
| Reverse primer: | |
| 5′-GCAAACTGTCTCCAGCTCCTTCTC-3′ | (SEQ. ID NO.: 8) |
| Annealing Temperature: 60° C. | |
| CHIN | |
| Forward primer: | |
| 5′-CCATCCAAAGAGTCTTGGTCAGG-3′ | (SEQ. ID NO.: 9) |
| Reverse primer: | |
| 5′-GTTGCCAGATTGTCACAGACGAC-3′ | (SEQ. ID NO.: 10) |
| Annealing Temperature: 60° C. | |
| CALM | |
| Forward primer: | |
| 5′-TGGCTGACCAACTGACTGAAGAG-3′ | (SEQ. ID NO.: 11) |
| Reverse primer: | |
| 5′-GTAACTCTGCTTCTGTGGGATTCTG-3′ | (SEQ. ID NO.: 12) |
| Annealing Temperature: 60° C. | |
| MYPR | |
| Forward primer: | |
| 5′-CTCAAAGGGTACTTCCACTGATGG-3′ | (SEQ. ID NO.: 13) |
| Reverse primer: | |
| 5′-CAATAGGCAGATTTGGGCAAAC-3′ | (SEQ. ID NO.: 14) |
| Annealing Temperature: 60° C. | |
| TBB3 | |
| Forward primer: | |
| 5′-ATGGGCACGTTGCTCATCAG-3′ | (SEQ. ID NO.: 15) |
| Reverse primer: | |
| 5′-TCGTTGTCGATGCAGTAGGTCTC-3′ | (SEQ. ID NO.: 16) |
| Annealing Temperature: 60° C. | |
| HB2J | |
| Forward primer: | |
| 5′-TGGTCTGCTCTGTGAGTGGTTTC-3′ | (SEQ. ID NO.: 17) |
| Reverse primer: | |
| 5′-TGTTTCCAGCATCACCAGGGTC-3′ | (SEQ. ID NO.: 18) |
| Annealing Temperature: 60° C. | |
| K2C8 | |
| Forward primer: | |
| 5′-CCATTAAGGATGCCAACGCC-3′ | (SEQ. ID NO.: 19) |
| Reverse primer: | |
| 5′-GACGTTCATCAGCTCCTGGTACTC-3′ | (SEQ. ID NO.: 20) |
| Annealing Temperature: 60° C. | |
| MT2 | |
| Forward primer: | |
| 5′-GCAAATGCACCTCCTGCAAG-3′ | (SEQ. ID NO.: 21) |
| Reverse primer: | |
| 5′-CGTTCTTTACATCTGGGAGCGG-3′ | (SEQ. ID NO.: 22) |
| Annealing Temperature: 60° C. | |
| RLA1 | |
| Forward primer: | |
| 5′-CATTCTGCACGACGATGAGGTG-3′ | (SEQ. ID NO.: 23) |
| Reverse primer: | |
| 5′-CAGATGAGGCTCCCAATGTTGAC-3′ | (SEQ. ID NO.: 24) |
| Annealing Temperature: 60° C. | |
| PTPZ | |
| Forward primer: | |
| 5′-AAACCTCGTGGAGAAAGGAAGG-3′ | (SEQ. ID NO.: 25) |
| Reverse primer: | |
| 5′-GCGTGTAGTGATACTGTGTGACCAC-3′ | (SEQ. ID NO.: 26) |
| Annealing Temperature: 60° C. | |
| EAT1 | |
| Forward primer: | |
| 5′-TGTGAGGACAGACAGAAGGCAAAG-3′ | (SEQ. ID NO.: 27) |
| Reverse primer: | |
| 5′-TGGGCTGGAAGAGACCATGAAGAC-3′ | (SEQ. ID NO.: 28) |
| Annealing Temperature: 60° C. | |
| TBB5 | |
| Forward primer: | |
| 5′-GAGTTCCCAGACCGCATCATG-3′ | (SEQ. ID NO.: 29) |
| Reverse primer: | |
| 5′-GATGTCGTAGAGTGCCTCGTTGTC-3′ | (SEQ. ID NO.: 30) |
| Annealing Temperature: 60° C. | |
| OSTP | |
| Forward primer: | |
| 5′-TGCAGCCTTCTCAGCCAAAC-3′ | (SEQ. ID NO.: 31) |
| Reverse primer: | |
| 5′-CCACAGCATCTGGGTATTTGTTG-3′ | (SEQ. ID NO.: 32) |
| Annealing Temperature: 60° C. | |
| AMO2 | |
| Forward primer: | |
| 5′-TGTGCCAGGACTCTCTTTCTTCC-3′ | (SEQ. ID NO.: 33) |
| Reverse primer: | |
| 5′-AAGGTTCAGTGTCCCCTGTGTCAG-3′ | (SEQ. ID NO.: 34) |
| Annealing Temperature: 60° C. | |
| PTRR | |
| Forward primer: | |
| 5′-TCAAGGACGCTGTGCTCTACTCTG-3′ | (SEQ. ID NO.: 35) |
| Reverse primer: | |
| 5′-CCAGGAAGTAAAGGAAGAAGGTCAC-3′ | (SEQ. ID NO.: 36) |
| Annealing Temperature: 60° C. | |
| SPCO | |
| Forward primer: | |
| 5′-TCAGGGTGTTTGGCATGTCC-3′ | (SEQ. ID NO.: 37) |
| Reverse primer: | |
| 5′-TGTGGGAGGAGATGAAGACCAC-3′ | (SEQ. ID NO.: 38) |
| Annealing Temperature: 60° C. | |
| ANX5 | |
| Forward primer: | |
| 5′-CCCTCATCAGAGTCATGGTTTCC-3′ | (SEQ. ID NO.: 39) |
| Reverse primer: | |
| 5′-TCATCTTCTCCACAGAGCAGCAG-3′ | (SEQ. ID NO.: 40) |
| Annealing Temperature: 58° C. | |
| RL10 | |
| Forward primer: | |
| 5′-AATTCGGCATGAGGGACCAC-3′ | (SEQ. ID NO.: 41) |
| Reverse primer: | |
| 5′-AATCTTGGCATCAGGGACACC-3′, | (SEQ. ID NO.: 42) |
| Annealing Temperature: 56° C. | |
| MAPB | |
| Forward primer: | |
| 5′-CGCTGAACAATTACCTGCCAAATG-3′ | (SEQ. ID NO.: 43) |
| Reverse primer: | |
| 5′-CCTAGCAGAAGTCAGTTGTGTTGG-3′ | (SEQ. ID NO.: 44) |
| Annealing Temperature: 60° C. | |

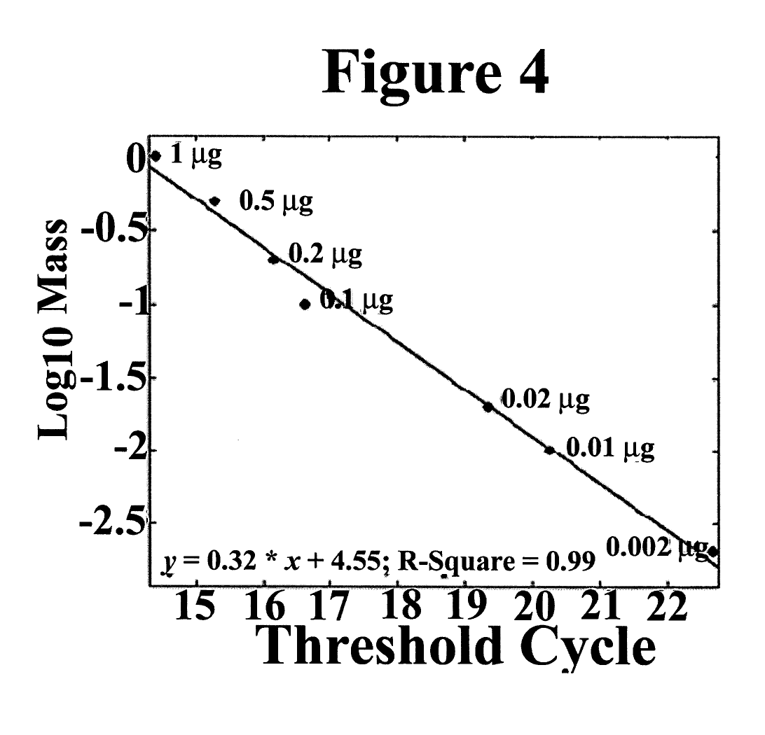

Titrated amounts of normal brain total RNA (configured as standard) and tumor total RNA samples (0.5 or 0.02 μg configured as unknown, Cepheid software) were assayed with each primer pair using SYBR green. Threshold cycles were computed as the maximum of the second differentials, and plotted against the log10 of the mass of normal brain total RNA. The plotted data fit linear curves whose equations permit computing the mass of normal brain RNA equivalent to 0.5 μg (or 0.02) of tumor RNA for a specific gene. The plotted data are shown in FIG. 4. Expression ratios normalized to G3PDH are:

$$\frac{\begin{matrix}Computed mass of \\ normal brain RNA for gene X\end{matrix}}{\begin{matrix}Computed mass of \\ normal brain RNA for G 3 PDH .\end{matrix}} \qquad ( 6.1 )$$

Algorithm:

The parameters used in the filtering algorithm were the same as those in Example 1. The algorithm was run with a reproducibility criterion requiring four of the four gene expression ratios for each gene to be of the same sign (rc=4).

Results:

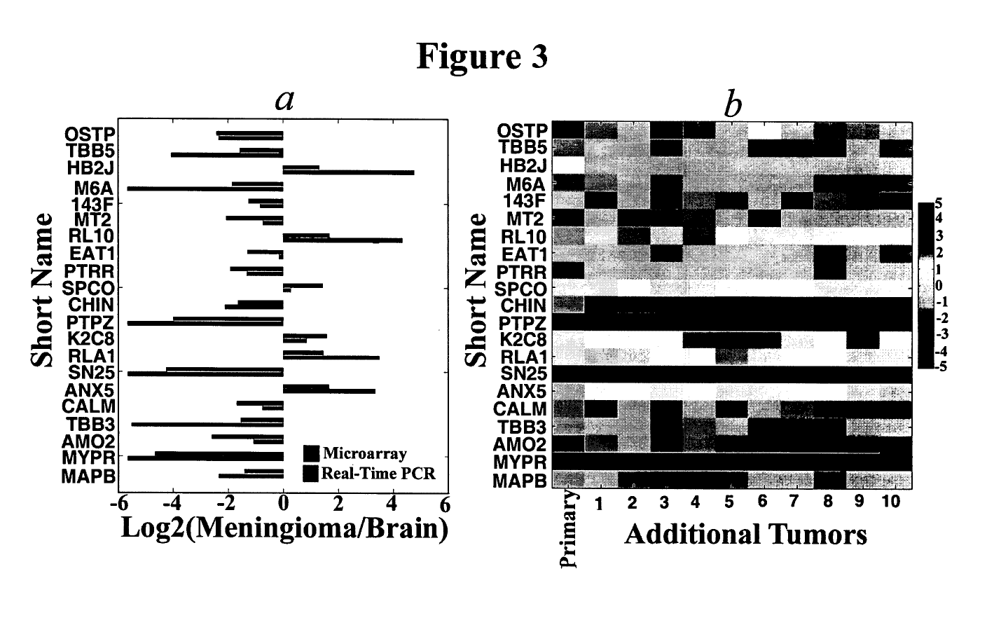

The mathematical algorithm discovers highly specific genes. Real-time RT PCR validated the states of expression (up or down-regulated) of all 21/21-extracted genes (FIG. 3a); the expression ratios (meningioma/normal brain) were capped at 50 and 0.02 folds. FIG. 3b shows the log2 measurements extracted by the algorithm from the profiling of a meningioma against normal brain by the 1.7K chips, and the log2 transformed normalized but unfiltered ratios in 10 other meningiomas profiled by the 19K microarray chips also against normal brain. Here, colors other than the gray scale at log2≠0 indicate that all 4 measurements consistently show either up- or down-regulation (rule f₀).

The mathematical analysis links the identified genes to the biology of meningiomas. The expression levels of 6 genes (RL10, RLA1, HB2J, K2C8, SPCO, and ANX5) are higher in meningiomas, and 15 genes are higher in normal brain. Two ribosomal related proteins (RL10 and RLA1) are upregulated in meningiomas. The QM protein (RL10; 60S Ribosomal Protein P1 L10) located on Xq28 is expressed in all adult tissues. Despite being isolated from a non-tumorigenic Wilms' tumor as a putative tumor suppressor gene (Dowdy et al., 1991), paradoxically the evidence is mounting that it may actually promote growth. It is downregulated during apoptosis and deleting its homologue in yeast, GCR5, causes growth arrest (Wiens et al., 1999; Koller et al., 1996). During mouse development, the QM protein is strongly expressed in chondrocytes within the transition zone of developing limb cartilage and within differentiated keratinocytes of the suprabasal region of the epidermis (Milss et al., 1999). In yeast, QM codes for an essential 60S ribosomal subunit protein that is required for the joining of the 40S and 60S subunits (Kguyen et al., 1998); furthermore, QM associates with ribosomes in the endoplastic reticulum (Loftus et al., 1997). In yeast, the 60S acidic ribosomal protein P1 (RLA1) is not required for cell viability but regulates the pattern of protein expression (Remacha et al., 1995). Beta-fodrin (SPCO), or the nonerythroid form of beta-spectrin, is a cytoskeletal protein related to actin that binds merlin-I, the product of the neurofibromatosis type 2 suppressor gene (Neill and Crompton, 2001). Beta-fodrin is upregulated in lung and infiltrating ductal carcinoma (Sormunen et al., 1994; Sormune et al., 1999). Cytokeratin 8 (K2C8) is upregulated in meningioma and is a marker of tumor progression in skin, breast, and cervical cancer (Larcher et al., 1992; Smedts et al., 1990; Guelstein et al., 1988; Assi et al., 1999); recent data from keratin 8-null mice have shown that keratin 8 attenuates tumor-necrosis factor and Fas-induced apoptosis (Inada et al., 2001; Gilbert et al., 2001). Annexin 5 (ANX5, anchorin CII) belongs to a large family characterized by its ability to bind to phospholipids in a calcium-dependent manner and to form calcium-specific ion channels. During mouse development, Annexin 5 is detected in parallel with vascular development and differentiation of cartilage and bone (Brachvogel et al., 2001). Both Zuk et al and Brunner et al have reported that expression of HLA class II-DR (HB2J) in breast cancer correlates with better prognosis (Brunner et al., 1991; Zuk and Walker, 1988).

Genes whose expression levels are higher in brain than meningioma include normal brain proteins, putative tumor suppressor genes, or both. Brain proteins include tubulin beta-3 and beta-5 chains (TBB3 and TBB5), copper amine oxidase precursor (AMO2), microtubule-associated protein 1B (MAPB), neuronal membrane glycoprotein M6a (M6a), synaptosomal associated protein 25 (SN25), myelin proteolipid protein (MYPR), protein-tyrosine phosphatase zeta precursor (PTPZ), calmodulin (CALM), excitatory amino acid transporter 1 (EAT1), and N-chimaerin (CHIN). N-chimaerin, involved in neuronal differentiation, also regulates Rac and Cdc42 GTPases (Hall et al., 2001). In addition, 14-3-3 proteins that also modulate the Ras pathway are lower in meningiomas than brain (Su et al., 2001; Freed et al., 1994). Hirota et al and Maier et al have shown that the expression of osteopontin precursor protein (OSTP, bone sialoprotein) and metallothionein 11 (MT2) are down-regulated in meningiomas (Hirota et al., 1995; Maier et al., 1997).

TABLE 1

| | Extracted | | |
|---|---|---|---|
| Comparison | Genes | # Genes | Microarray |
| Brain RNA vs. Brain RNA | 1 | 17,280 | 1.7K |
| Meningioma vs. Brain RNA | 21 | 1,920 | 1.7K |
| Brain RNA vs. Brain RNA | 1 | 192,000 | 19K |
| Table 1: The mathematical algorithms are effective in filtering noise. Only 1 of the total of 17,280 genes analyzed was not excluded in 9 probe switching experiments comparing normal brain RNA to itself (1.7K chip). In this design, any expression ratio ≠ 1 is false positive. In addition, an only 1 of 192,000 genes analyzed in 10 probe switching experiments was not filtered (19K chip). The analysis of a meningioma RNA vs. normal human brain extracts 21 genes out of 1920. | | | |
| # The algorithm outputs the log2 of the mean of the 4 replicate normalized ratios. | | | |

Cited references: Alizadeh, A A et al. 2000. Distinct types of diffuse late B-cell lymphomas identified by gene expression profiling. Nature 403, 503-511; Alter, O., Brown, and Botstein, D. 2000. Singular value decomposition for genome-wide expression data processing and modeling. Proc Natl Acad Sci USA 97, 10101-10106; Assi, A., Declich, P., Iacobellis, M., Cozzi, L., and Tonnarelli, G. 1999. Secretory meningioma, a rare meningioma subtype with characteristic glandular differentiation: an histological and immunohistochemical study cases. Adv Clin Path 3 47-53; Baggerly, K., Coombes, K., Hess, K., Stivers, D., Abruzzo, L., and Zhang, W. 2001. Identifying differentially expressed genes in cDNA microarray experiments. J Comp Biol 8, 639-659; Bittner, M. et al. 2001. Molecular classification of cutaneous melanoma by gene expression profiling. Nature 406, 536-539; Brachvogel, B., Welzel, H., Moch, H., von der Mark, K., Hofmann, C., and Poschl, E. 2001. Sequential expression of annexin A5 in the vasculature and skeletal elements during mouse development. Mech Dev 109, 389-393; Brunner, C., Gokel, J., and Riethmuller, J J. 1991. Expression of HLA-D subloci DR and DQ by breast carcinoma is correlated with distinct parameters of favorable prognosis. Eur J Cancer 27, 411-416; Cheng, Q., Lau, W., Tay, S., Chew, S., Ho, T., and Hui, K. 2002. Identification and characterization of genes involved in the carcinogenesis of human squamous cell cervical carcinoma. Int J Cancer 98, 419-426; Dowdy, S., Lai, K., Weissman, B., Matsui, Y., Hogan, B., and Stanbridge, E. 1991. The isolation and characterization of a novel cDNA demonstrating an altered mRNA level in nontumorigenic Wilms' microcell hybrid cells. Nucleic Acids Res 19, 5763-5769; Fathallah-Shaykh, H M, Rigen, M., Zhao, L. -J., Bansal, K., He, B., Engelhard, H., Cerullo, L., Von Roenn, K., Byrne, R., Munoz, L., Rosseau, G., Glick, R., Lichtor, T., and DiSavino, E. 2002. Mathematical modeling of noise and discovery of genetic expression classes in gliomas. Oncogene In Press; Freed, E., Symons, M., Macdonald, S., mcCormick, F., and Ruggieri, R. 1994. Binding of 14-3-3 proteins to the protein kinase Raf and effects on its activation. Science 265, 1713-1716; Gilbert, S., Loranger, A., Daigle, N., and Marceau. N. 2001. Simple epithelium keratins 8 and 18 provide resistance to Fas-mediated apoptosis. The protection occurs through a receptor-targeting modulation. J Cell Biol 154, 763-773; Golub, T. R., Slonim, D. K., Tamayo, P., Huard, C., Gaasenbeek, M., Mesirov, J. P., Coller, H., Loh, M. L., Downing, J. R., Caligiuri, M. A., Bloomfield, C. D., and Lander, E. S. 1999. Molecular classification of cancer: class discovery and class prediction by gene expression monitoring. Science 286, 531-537; Guelstein, V., Tchypysheva, T., Ermilova, V., Litvinova, L., Troyanovsky, S., and Mannikov, G. 1988. Monoclonal antibody mapping of keratins 8 and 17 and of vimentin in normal human mammary gland, benign tumors, dysplasias and breast cancer. Int J Cancer 1988, 147-153; Hall, C., Michael, G., Cann, N., Ferrari, G., Teo, M., Jacobs, T., Monfries, C., and Lim, L. 2001. Alpha2-chimaerin, a Cdc42/Rac1 regulator, is selectively expressed in the rat embryonic nervous system and is involved in neurogenesis in N1E-115 neuroblastoma cells. J Neurosci 21, 5191-5202; Hirota, S., Yoshikazu, Y., Yoshimine, T., Kohri, K., Nomura, S., Taneda, M., Hayakawa, T., and Kitamura, Y. 1995. Expression of bone-related protein messenger RNA in human meningiomas: possible involvement of osteopontin in development of psammoma bodies. J Neuropathl Exp Neurol 54, 698-703; Inada, H., Izawa, I., Nishizawa, M., Fujita, E., Kiyono, T., Takahashi, T., Momoi, T., and Inagaki, M. 2001. Keratin attenuates tumor necrosis factor-induced cytotoxicity through association with TRADD. J Cell Biol 155, 415-426; Kguyen, Y., Mills, A., and Stanbridge, E. 1998. Assembly of the QM protein onto the 60S ribosomal subunit occurs in the cytoplasm. J Cell Biochem 68, 281-285; Koller, H., Klade, T., Ellinger, A., and Breitenbach, M. 1996. The yeast growth control gene GRC5 is highly homologous to the mammalian putative tumor suppressor gene QM. Yeast 12, 53-65; Kondoh, N., Shuda, M., Tanaka, K., Wakatsuki, T., Hada, A., and Yamamoto, M. 2002. Enhanced expression of S8, L12, L23a, L27, and L30 ribosomal protein mRNAs in human hepatic cell carcinoma. Anticancer Res 21, 2429-2433; Larcher, F., Bauluz, C., Diaz-Guerra, M., Quintanilla, M., Conti, C., Ballestin, C., and Jorcano, J. 1992. Aberrant expression of the simple epithelial type 11 keratin 8 by mouse skin carcinomas but not papillomas. Mol Carcinog 6, 112-121; Li, B., Sun, M., He, B., Yu, J., Zhang, Y., and Zhang, Y. 2002. Identification of differentially expressed genes in human uterine leiomyomas using differential display. Cell Res 12, 39-45; Loftus, T., Nguyen, Y., and Stanbridge, E. 1997. The Qm protein associated with ribosomes in the rough endoplastic reticulum. Biochemistry 36, 8224-8230; Maier, H., Jones, C., Jasani, B., Ofner, D., Zelger, B., Werner, K., Schmid, K., and Budka, H. 1997. Metallothionein overexpression in human brain tumors. Acta Neuropathol 94, 599-604; Milss, A., Mills, M., Gardiner, D., Bryant, S., and Stanbridge, E. 1999. Analysis of the pattern of QM expression during mouse development. Differentiation 64, 161-171; Neill, G. and Crompton, M. 2001. Binding of the merlin-I product of the neurofibromatosis type 2 tumor suppressor gene to a novel site in beta-fodrin is regulated by association between merlin domains. Biochem J 358, 727-735; Newton, M., Kendziorski, C., Richmond, C., Blattner, F., and Tsui, K. 2001. On differential variability of expression ratios: improving statistical inference about gene expression changes from microarray data. J Comp Biol 8, 37-52; Pomeroy S L, et al. 2002. Prediction of central nervous system embryonal tumor outcome based on gene expression. Nature 415, 436-442; Remacha, M., Jimenez-Diaz, A., Bermejo, B., Rodriguez-Gabriel, M., Guarinos, E., and Ballesta, J. 1995. Ribosomal acidic phosphoproteins P1 and P2 are not required for cell viability but regulate the pattern of protein expression in Saccharomyces cerevisiae. Mol Cell Biol 15, 4754-4762; Smedts, F., Ramaekers, F., Robben, H., Pruszcsynski, M., van Muijen, G., Lane, B., Leigh, I., and Vooijs, P. 1990. Changing patterns of keratin expression during progression of cervical intraepithelial neoplasia. Am J Pathol 136, 657-668; Sormune, R., Leong, A., Vaaraniemi, J., Fernando, S., and Eskelinen, S. 1999. Immunolocalization of the fodrin, E-cadherin, and beta-catenin adhesion complex in infiltrating ductal carcinoma of the breast-comparison with an in vitro model. J Pathol 187, 416-423; Sormunen, R., Paakko, P., Palovuori, R., Soini, Y., and Lehto, V. 1994. Fodrin and actin in the normal, metaplastic, and dysplastic respiratory epithelium and in lung carcinoma. Am J Respir Cell Mol Biol 11, 75-84; Su, T., Parry, D., Donahoe, B., Chien, C., O'Farrell, P., and Purdy, A. 2001. Cell cycle roles for two 14-3-3 proteins during Drosophila development. J Cell Sci 114, 3445-3454; Theilhaber, J., Bushnell, S., Jackson, A., and Fuchs, R. 2001. Bayesian estimation of fold-chnages in the analysis of gene expression: the PFOLD algorithm. J Comp Biol 8, 585-614; Tusher, V., Tibshirani, R., and Chu, G. 2001. Significance analysis of microarrays applied to the ionizing radiation response. Proc Natl Acad Sci USA 98, 5116-5121; Watkins, S. and Norburg, C. 2002. Translation initiation and its deregulation during tumorigenesis. Br J Cancer 86, 1023-1027; Wiens, M., Koziol, C., Hassanein, H., Muller, I., and Muller, W. 1999. A homolg of the putative tumor suppressor QM in the sponge Suberitus domuncula: downregulation during the transition from immortal to mortal (apoptotic) cells. Tissue Cell 31, 163-169; Yank, Y., Dudoit, S., Luu, P., Lin, D., Peng, V., Ngai, J., and Speed, T. 2002. Normalization of cDNA microarray data; a robust composite method addressing single and multiple slide systematic variation. Nucleic Acids Res 30, el 5; Zuk, J. and Walker, R. 1988. HLA class 11 sublocus expression in benign and malignant breast epithelium. J Pathol 155, 301-309.

### Example 3

### Demonstration of the Algorithm on a Comparative System II

To explore the idea that genomic expression discovery predicts pathways and functions behind the biological phenotypes of living systems, a tumor was compared to its normal host organ. The expression data accurately predicted activation of signaling pathways and proposed that unbalanced opposing genetic functions create ‘aberrant’ phenotypes. In addition, known molecular interactions revealed a rich network of stimulatory and inhibitory genetic interconnections.

Microarrays containing 19,200 cDNAs to profile gene expression in 10 meningiomas vs. normal brain were used in the experiment. These studies are described in more detail in J. Biological Chemistry, vol. 278, pages 23830-23833 (2003), which is incorporated herein by reference. Meningiomas were compared to normal brain, its host organ, because both tissue types contain non-tumor cells like blood vessels and cells of lymphocytic lineage. Meningiomas comprise 15-20% of all primary intracranial tumors. They are abundantly vascular, tend to bleed during surgery, and often show ectopic calcification on CT scanning.

Experimental Procedure:

Reagents:

Information on the antibodies used may be obtained from the corresponding web sites. Anti-beta-catenin were purchased from Upstate biotech, 300 5th Avenue, 6th Floor, Waltham, Mass. 02451. Anti-glyceraldehydes-3-phosphate dehydrogenase (G3PDH), www.trevigen.com. Anti-Akt, anti-phospho-Akt (Ser473), anti-p44/42 MAP kinase (ERK), and anti-phospho-p44/p42 Map Kinase (Thr202/tyr204, ERK-P) were purchased from Cell Signaling Technology, Inc, 166B Cummings Center, Beverly, Mass. 01915.

Microarrays Experiments:

Tumor samples were frozen in liquid nitrogen in the operating room. The quality of RNA was assayed by gel electrophoresis; only high quality reference and sample RNAs were processed.

All total RNA samples were analyzed in reference to a single standard obtained by pooling RNA from human occipital lobes. The latter were harvested and pooled from 4 individuals with no known neurological disease whose brains were frozen less than 3 hours postmortem. Total RNA (5-10 μg) was reverse transcribed and the cDNA products labeled by the amino-allyl method and hybridized to 19K gene microarrays purchased from the Ontario Cancer Institute. Each 19K microarray consisted of 2 slides containing a total of 38400 spots representing 19200 genes laid in duplicates (19200 spots/slide). The 19K microarray slides were scanned at 10 μm by a confocal scanner (Packard 4000XL scanner, Packard Bioscience; Meriden Conn.). Images were analyzed by the Imagene Software (Biodiscovery; Los Angeles, Calif.).

Algorithm:

The algorithm was applied to find the genes differentially expressed in each tumor sample as compared to normal brain. The variables used in the algorithm are as follows: c=2, C=0.36, rc=4, and z=3. To annul the effects of sample-to-sample variability in image quality in generating false negative data, these steps were followed in order: 1) apply the algorithm to find the genes differentially expressed in each tumor sample as compared to normal brain, 2) find the set of genes, S, that are extracted by the algorithm in at least one of the 10 tumors, and 3) identify the 4 ‘raw’ replicate ratios of each of the genes of S in each tumor. A filter consisting of the following “fuzzy logic” rules in sequence was then applied: 1) all 4 replicate log2 (ratios) of a gene in any tumor are of the same sign and different than 0 (all 4 show either up- or down-regulation); 2) the mean of the 4 replicate ratios is either >1.5 or <0.67; 3) if both rules 1 and 2 are true, compute the mean of the replicate log2 expression values; otherwise, exclude the genes by transforming the log2 expression to 0; 4) exclude genes that are not resistant to both rules 1 and 2 in at least 5/10 tumors; and 5) exclude genes that are simultaneously upregulated in a tumor and down-regulated in another.

Results:

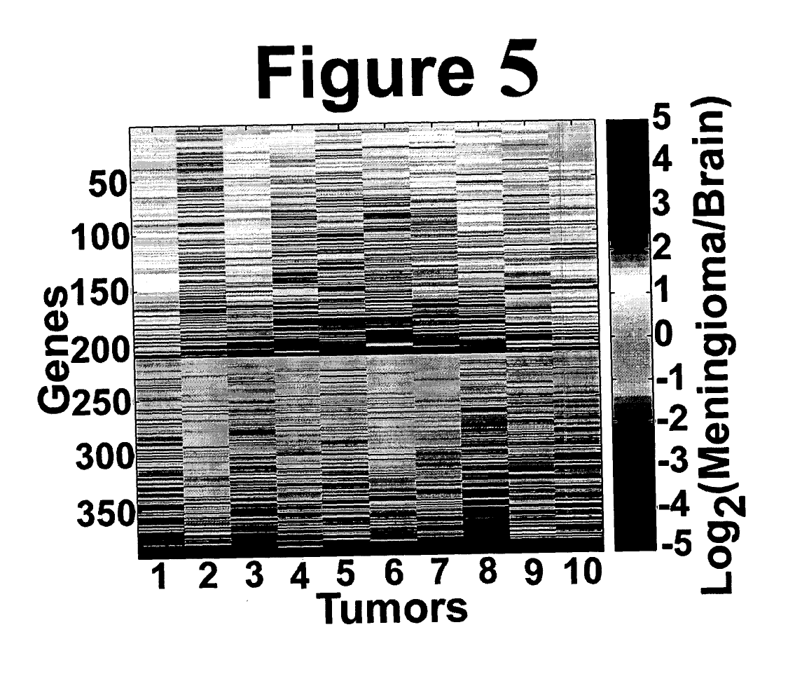

The results revealed that 364 genes are consistently up- or downregulated in at least 5/10 meningiomas as compared to normal brain. FIG. 5 shows these results. cDNAs, spotted at several sites on a slide, were configured in multiple rows. The genes and their differential expression are presented in the supplement (supp) to J. Biological Chemistry, vol. 278, pp. 23830-23822 (2003); 256 genes are either known or are ESTs homologous to known genes. The remaining are uncharacterised ESTs. A colored rendition of FIG. 5 which clearly shows which genes were filtered, which were upregulated and which were downregulated is provided in J. Biological Chemistry, Vol. 278, pp. 23830-23833 (2003).

The findings propose several hypotheses; elevated expression of dyskerin contributes to the previously reported telomerase activity in meningiomas. See, Langford L A, Piatyszek M A, Xu R, Schold S C Jr, Wright W E, and Shay J W (1997) Hum Pathol 28, 416-420. Loss of Tho2 and higher expression of PRKDC are consistent with genomic instability. As compared to normal brain, transcriptional activity is enhanced in meningiomas as evidenced by: 1) upregulation of PSIP2, a transcriptional enhancer, 2) down-regulation of NCOR2, a transcriptional repressor, and 3) upregulation of the transcription factors TAF13, ZNRD1, MLL3, NET1, and three zinc finger proteins. Transcriptional activation is associated with enhanced expression of genes that regulate RNA processing, splicing, and degradation including WBP11, HNRPK, PCBP2, and genes homologous to tRNA ligase and to PAN2. Enhanced transcriptional activity is also coupled with higher translational activity as evidenced by elevated expression levels of ribosomal proteins in meningiomas.

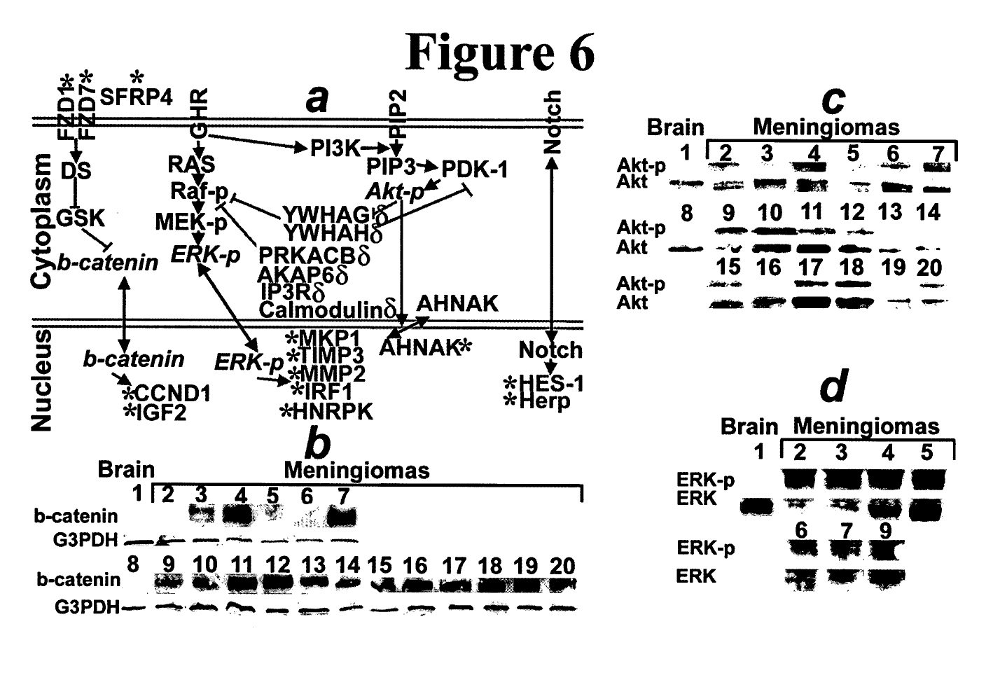

Signaling pathways transmit information by phosphorylating specific proteins at specific sites. An assay that quantifies mRNA expression does not detect changes in protein phosphorylation; nevertheless, one expects microarrays to discover genes that are either targeted by the tumor or transcriptionally regulated when the signaling reaches the nucleus. FIG. 6a shows the differentially expressed genes related to the Wnt, MAP kinase, PI3K, and notch signaling and how they fit into the known molecular interactions of these pathways. FIG. 6(a) is a cartoon portraying how some of the differentially expressed genes fit into the Wnt, MAPK, PI3K, and notch signaling pathways. Genes that are upregulated or downregulated in meningiomas as compared to normal brain are labeled * and δ, respectively. Inhibitory and stimulatory (facilitating) ‘interactions’ are depicted with trancated gray arrows and full gray arrows, respectively. Full gray arrows in the nuclear compartment imply induction of transcription. The double solid arrows indicate translocation between cellular compartments. Double lines depict the nuclear and plasma membranes. DS, disshelved; GHR, growth hormone receptor; MEK, dual-specificity kinase; ERK, MAP kinase; -p, phosphorylated protein; PI3K, phosphoinositide 3-kinase; PDK-1, phosphoinositide-dependent kinase 1; PIP2, phosphatidylinositol-4,5-bisphosphate; PIP3, phosphatidyl-inositol-3,4,5-triphosphate; Akt, protein kinase B. (b-d) confirm the activation of the Wnt, MAP kinase and PI3K signaling pathways in meningiomas. Western analysis of extracts from normal brain (lanes 1 and 8) and 18 meningiomas (lanes 2-7 and 9-20) reacted with antibodies against beta catenin (b), glyceraldehydes-3-phosphate dehydrogenase (G3PDH, b), Akt (c), phospho-Akt (Ser473, Akt-p, c), p44/42 MAP kinase (ERK, d), and phospho-p44/p42 Map Kinase (Thr202/tyr204, ERK-P, d).

The expression data reveal upregulation of frizzle receptors, cyclin D1, and IGF2 in meningiomas. Activation of the upregulated frizzle receptors is expected to lead to inhibition of GSK3-beta, which causes accumulation of the beta catenin protein and its translocation to the nucleus where it induces the expression of cyclin D1 and IGF2. As predicted by the gene expression data (FIG. 6a), western analysis confirms the activation of Wnt signaling as evidenced by significantly higher amounts of the beta catenin protein in 11/18, and moderately increased amounts in 4/18 meningiomas as compared to normal brain (FIG. 6b). Loss of molecules that complex with protein kinase A (calmodulin 2, PRKACB, AKAP6, and ITPR1) and downregulation of the 14-3-3 proteins (YWHAG and YWHAH) predict enhanced signaling through the MAP kinase and P13K pathways. Moreover, the enhanced expression of MKP1, TIMP3, MMP2, IRF1, and HNRPK in meningiomas also imply activation of the MAP kinase pathway. Here again, as predicted by the gene expression data, protein analysis confirms the activation of the MAP kinase and PI3K pathways as evidenced by phosphorylation of ERK (MAP kinase) and Akt (protein kinase B) in 7/7 and 12/18 meningiomas but not in normal brain, respectively (FIG. 6). Activation of both the MAP kinase and PI3K pathways enhance signaling through the notch pathway, which explains the elevated expression levels of HES-1 and Herp in meningiomas. Notch signaling is necessary to maintain the neoplastic phenotype in Ras-transformed human cells. G-proteins and G-protein coupled receptors appear to play critical roles in signaling and growth. These include molecules that regulate signaling by controlling the intrinsic rate at which Ras, Rho and Rab GTPases cycle between active GTP-bound and inactive GDP-bound states. In addition, RGS4 hinders growth by inhibiting platelet-activating factor receptor phosphorylation.

Growth is enhanced by: 1) the production of growth factors and their binding proteins including IGF2, IGFBP3, IGFBP4, IGFBP5, NOV, and CTGF; 2) The expression of the mitogenic receptors CD14 and LRP1; and 3) the downregulation of molecules that dampen signaling downstream from growth receptor activation; specifically, RGS4, PTPNS1, endophilin 1, and dynamin, which reduce receptor kinase-coupled signaling. The cell cycle is deregulated in meningiomas. Cyclin D1, E2F1, BTG2, and ID1, which direct G1/S transition, are upregulated. NET1, which controls mitotic exit by anchoring the budding yeast RENT complex to the nucleolus, is also upregulated. Downregulation of genes that arrest the cell cycle including CENPE, YWHAH, and YWHAG, suggest deficient cell cycle control. CENPE is required for establishing and maintaining a checkpoint that delays anaphase onset until all centromeres are correctly attached to the mitotic spindle. YWHAH and YWHAG belong to the 14-3-3 family of proteins that arrest the cell cycle at G2.

Transformation is induced by: 1) enhanced expression of the oncogenes ARNT, DSCR2, NET1, PTPN2, ID1, and MN1; 2) upregulation of anti-apoptotic genes including Herp, HES-1, and S100A10; 3) downregulation of the tumor suppressor genes TU3A, PEG3, and C30RF4; and 4) downregulation of the pro-apoptotic genes ITPR1 (Table 2, supp), ATP2B1, BNIP3, and BACH2. In addition, molecules, that interact with and modulate the effects of oncogenes and tumor suppressor genes, are transcriptionally regulated. Specifically, downregulation of FTH1 is necessary for the ability of myc to induce cellular transformation. SCHIP1 and members of the 14-3-3 protein family (YWHAG and YWHAH) react with merlin. EB1 and TTC2 interact with adenomatous polyposis coli (APC) and neurofibromin (NF1 gene), respectively.

The enhanced expression of ATWP may be in response to a higher energy requirement of the tumor cells. Interestingly, channels that conduct chloride, potassium, calcium, sodium, and bicarbonate and proteins that bind and regulate these channels are transcriptional regulated in meningiomas. The findings link ion homeostasis to the biology and phenotypes of meningiomas. The expression of molecules involved in cell-cell and cell-matrix interactions (STAB2 and EMP1), gap junctions (connexin 26), basal lamina (LAMB1 and LAMB2), and desmosomes (desmoplakin and DSG1) are higher in meningiomas than brain.

The cytoskeleton of meningiomas is likely to contain higher amounts of keratins 7 and 8 but lower amounts of tubulin than brain. In addition, the expression levels of the actin-binding proteins T-plastin (PLS3), ARHA, ARHC, SDC2, TPM1, EPLIN-beta, DMD, CALD1, and AHNAK are higher, while the expression levels of molecules that regulate microtubules dynamics including EB1 and STMN1 are lower in meningiomas than brain. Syntenin, which couples the transmembrane proteoglycans syndecans to cytoskeletal proteins, is down-regulated. PNUTL1 and SEPT, members of the septin family that regulate cell division and interact with actin and microtubules, are also down-regulated.

Meningiomas often produce cartilage and ectopic calcification; the tumors show higher expression of some types of collagen than brain. Upregulation of the proteoglycans fibromodulin and decorin and loss of Rore2 suggest deposition of ‘atypical’ cartilage. The extracellular matrix of meningiomas seems to be undergoing active remodelling as evidenced by higher expression of cathepsin L, MMP2, TIMP3, and lower expression of testican 3 than brain. Cathepsin L and MMP2 break down the extracellular matrix; the latter also degrades type IV collagen. Testican 3 regulates the activation of matrix metalloproteinases and TIMP3 prevents the degradation of proteoglycans.

Ectopic bone formation is mediated by: 1) enhanced expression of genes that induce and facilitate ectopic calcification including CDH11, SLC26A2, SLC20A2, Endol 80, OIF, SPARC, GDF11, and ALPL; 2) production of OPG, a competitor that inhibits bone resorption by RANKL; and 3) downregulation of MGP, an inhibitor of cartilage calcification.

Several hypoxia-inducible and/or angiogenesis-promoting genes are upregulated in meningiomas including EDNRA, EDNRB, PGF, CTGF, FN1, MMP2, SPARC, and ARNT. PEGF, a potent inhibitor of angiogenesis, is also upregulated; the findings support the idea of Ohno-Matsui that angiogenesis is generated by disruption of a critical balance between PEGF and angiogenesis-promoting molecules. See, Ohno-Matsui K, Morita I, Tombran-Tink J, Mrazek D, Onodera M, Uetama T, Hayano M, and Mochizuki M (2001) J Cell Physiol 189, 323-333. Interestingly, meningiomas also appear to actively maintain a viable blood supply by producing molecules that prevent blood clotting. The latter include the vitamin K-dependent protein S(PROS1), and genes that regulate the complement cascade.

To survive within a host, the tumor needs protection from the immune response. Meningiomas appear to evade immunological surveillance by: 1) regulating the classical and alternate complement cascade to escape from complement-mediated killing; 2) upregulating MMP2 and the protease inhibitor SLP1 to dampen the local immune response; 3) downregulating VAP1 and the cerebral cell adhesion molecule to block lymphocyte migration across the blood brain barrier; and 4) enhancing the expression of JAM2 to ‘seal’ the blood brain barrier. In addition, PROL4 may contribute ‘an adaptive barrier function’. Others have reported expression states in meningiomas that are consistent with our data. See, Watson M A, Peterson K, Chicoine M R, Kleinschmidt-DeMasters B K, Brown H G, and Perry A (2002) Am J Path 161, 665-672. Some of the expression states of this study, including the ESTs have also been reported in gliomas by this laboratory. See, Fathallah-Shaykh, H., Rigen, M., Zhao, L. -J., Bansal, K., He, B., Engelhard, H., Cerullo, L., Von Roenn, K., Byrne, R., Munoz, L., Rosseau, G., Glick, R., Lichtor, T., and DiSavino, E. (2002) Oncogene 21, 7164-7174. Eleven ESTs are downregulated in both gliomas and meningiomas and four ESTs are upregulated in both tumors as compared to brain; linking ESTs to tumors and their genetic networks is an important step in investigating their functions.

The results demonstrate the relevance of genomic expression discovery to functional genomics; specifically genomic expression discovery predicts activation of signaling pathways and uncovers unbalanced opposing functions behind specific phenotypes. The findings suggest the principles of multiplicity and balanced genetic expression. Multiplicity is apparent because of the multi-functionality of single genes, and because a given phenotype is caused not by a single molecule, but rather by upregulating several genes that promote a desirable ‘aberrant’ function and by downregulating a number of genes that prevent it. Thus, a ‘normal’ biological phenotype seems to be created, maintained, and controlled by a tight balancing of opposing molecular functions. Meningiomas disturb this balanced expression to promote their phenotypes. Known genetic functions and interactions draw multiple stimulatory and inhibitory connections (FIG. 6). Uncovering the diverse functions of the individual genes including the ESTs seems necessary for configuring a 2-dimensional scene of genetic interactions; however, it may not be sufficient for engendering an understanding of how the genes work together to make the totality. A mathematical simulation of the dynamics may enhance our ability to see the system as a whole and to understand how these 364 genes create the biological phenotypes. See, Davidson, E. and et al. (2002) Science 295, 1669-1678; and Csete M E and Doyle J C (2002) Science 295, 1664-1669. The findings demonstrate the significance and cost-effectiveness of discovering highly specific states of genetic expression.

### EQUATIONS

$$Equation ( 1.2 ) \text{:} DERIVATIVE OF EQUATION 1.1$$

$${f}^{′} ( x ) = ( \frac{{a}_{1} * {a}_{2}}{{( x + {a}_{2} )}^{2}} + \frac{3840 + {a}_{3}}{{( 3840 - x + {a}_{3} )}^{2}} ) * {a}_{5} * ( \frac{1}{1 + {( \frac{{a}_{7}}{x} )}^{{a}_{6}}} + \frac{{a}_{8}}{1 + {( \frac{{a}_{10}}{x} )}^{{a}_{9}}} - \frac{{a}_{11}}{x + {a}_{12}} ) * ( 1 + \frac{{a}_{13}}{1 + {\vert 1 - \frac{{a}_{15}}{x} \vert}^{{a}_{14}}} ) ( \frac{{a}_{1} * x}{x + {a}_{2}} + \frac{x}{3840 - x + {a}_{3}} - {a}_{4} ) * {a}_{5} * ( \frac{\frac{{a}_{6}}{x} * {( \frac{{a}_{7}}{x} )}^{{a}_{6}}}{{( 1 + {( \frac{{a}_{7}}{x} )}^{{a}_{6}} )}^{2}} + \frac{{a}_{8} * \frac{{a}_{9}}{x} * {( \frac{{a}_{10}}{x} )}^{{a}_{9}}}{{( 1 + {( \frac{{a}_{10}}{x} )}^{{a}_{9}} )}^{2}} + \frac{{a}_{11}}{{( x + {a}_{12} )}^{2}} ) * ( 1 + \frac{{a}_{13}}{1 + {\vert 1 - \frac{{a}_{15}}{x} \vert}^{{a}_{14}}} ) + ( \frac{{a}_{1} * x}{x + {a}_{2}} + \frac{x}{3840 - x + {a}_{3}} - {a}_{4} ) * {a}_{5} * ( \frac{1}{1 + {( \frac{{a}_{7}}{x} )}^{{a}_{6}}} + \frac{{a}_{8}}{1 + {( \frac{{a}_{10}}{x} )}^{{a}_{9}}} - \frac{{a}_{11}}{x + {a}_{12}} ) * ( \frac{{a}_{13} * {a}_{14} * sign ( {a}_{15} - x ) * ( \frac{{a}_{15}}{{x}^{2}} ) * {\vert 1 - \frac{{a}_{15}}{x} \vert}^{{a}_{14} - 1}}{{( 1 + {\vert 1 - \frac{{a}_{15}}{x} \vert}^{{a}_{14}} )}^{2}} ) + \frac{{a}_{19} * ( \frac{{a}_{16}}{x} ) * {( \frac{{a}_{17}}{x} )}^{{a}_{16}}}{{( 1 + {( \frac{{a}_{17}}{x} )}^{{a}_{16}} )}^{2}}$$

The following embodiments are non-limiting examples of various embodiments contemplated by the present invention.

A method of eliminating false differentials between data matrices collected from two samples comprising the steps of:
(a) providing a first sample and a second sample;
(b) providing at least four replicate matrix pairs wherein each pair comprises a data matrix for the first sample and a data matrix for the second sample, each data matrix comprising a plurality of data points, each data point providing a signal having an intensity, each signal corresponding to a selected property of the samples, wherein each data point in a given matrix has a corresponding data point in the other matrices, such that corresponding data points provide information about the same property of the samples;
(c) identifying and eliminating the data points in the matrices having signal intensities below a background noise level;
(d) identifying and eliminating any remaining data points having signals that are substantially indistinguishable from other signals in the same matrix, wherein signals are substantially indistinguishable if they fail to meet a predetermined distinguishability criterion;
(e) determining signal intensity ratios for corresponding data points in each pair of matrices, wherein the signal intensity ratio for two corresponding data points in each matrix pair has a corresponding signal ratio in each of the other matrix pairs; and
(f) identifying and eliminating any remaining data points that provide intensity ratios that are substantially irreproducible, wherein intensity ratios are substantially irreproducible if they fail to meet a predetermined reproducibility criterion.

The method of paragraph 108 wherein step (c) comprises:
(a) ranking the data points within each data matrix according to signal intensity to generate an experimental curve showing the increase in signal intensity as a function of rank; and
(b) fitting a smooth model curve to each experimental curve, the model curve comprising a first rising section and a second rising section, the first rising section and the second rising section being separated by an inflection point, wherein all data points having an intensity equal to or below the intensity level at the inflection point are eliminated from that data matrix.

The method of paragraph 109 wherein the intensity axis of the experimental curve has a log scale.

The method of paragraph 109 wherein the model curve is produced by the equation:

$$\begin{matrix}f ( x ) = ( \frac{{a}_{1}^{*}}{x + {a}_{2}} + \frac{x}{{r}_{max} - x + {a}_{3}} - {a}_{4} ) * {a}_{5} * \\ ( \frac{1}{1 + {( \frac{{a}_{7}}{x} )}^{{a}_{6}}} + \frac{{a}_{8}}{1 + {( \frac{{a}_{10}}{x} )}^{{a}_{9}}} - \frac{{a}_{11}}{x + {a}_{12}} ) * \\ ( 1 + \frac{ {a}_{ 13}}{ 1 + {\vert 1 - \frac{ {a}_{ 15}}{ x} \vert}^{{a}_{14}}} ) + ( \frac{1}{1 + {( \frac{{a}_{17}}{x} )}^{{a}_{16}}} - {a}_{18} ) * {a}_{19}\end{matrix}$$

The method of paragraph 108 wherein step (d) comprises:
(a) ranking the remaining data points within each data matrix according to signal intensity to generate an experimental curve showing the increase in signal intensity as a function of rank;
(b) fitting a smooth model curve to each experimental curve;
(c) selecting a threshold slope change along the model curves that corresponds to a minimum detectable fractional intensity change between consecutively ranked data points in the data matrices, wherein a fractional intensity change is detectable if it meets a predetermined detectability criterion;
(d) identifying an analytical rank for each data matrix, the analytical rank corresponding to the rank of the lowest ranking data point in each data matrix having a fractional intensity change, relative to its consecutively ranked data points, that is equal to or greater than the minimum detectable fractional intensity change; and
(e) eliminating the data points in each matrix pair that have a rank lower than the largest analytical rank for all the model curves.

The method of paragraph 111 wherein the intensity axis of the experimental curve has a log scale.

The method of paragraph 111 wherein the model curve is produced by the equation:

$$\begin{matrix}f ( x ) = ( \frac{{a}_{1}^{*}}{x + {a}_{2}} + \frac{x}{{r}_{max} - x + {a}_{3}} - {a}_{4} ) * {a}_{5} * \\ ( \frac{1}{1 + {( \frac{{a}_{7}}{x} )}^{{a}_{6}}} + \frac{{a}_{8}}{1 + {( \frac{{a}_{10}}{x} )}^{{a}_{9}}} - \frac{{a}_{11}}{x + {a}_{12}} ) * \\ ( 1 + \frac{ {a}_{ 13}}{ 1 + {\vert 1 - \frac{ {a}_{ 15}}{ x} \vert}^{{a}_{14}}} ) + ( \frac{1}{1 + {( \frac{{a}_{17}}{x} )}^{{a}_{16}}} - {a}_{18} ) * {a}_{19}\end{matrix}$$

The method of paragraph 113 wherein the slope change along the model curve is determined by taking the derivative of the equation of paragraph 87.

The method of paragraph 111 wherein the minimum detectable fractional intensity change between two consecutively ranked data points is calculated by multiplying a constant by the intensity of the highest ranking data point divided by the rank of the highest ranking data point.

The method of paragraph 115 wherein the constant is between 0.35 and 0.37.

The method of paragraph 115 wherein the constant is determined empirically.

The method of paragraph 108 wherein step (f) comprises:
(a) classifying the signal intensity ratios for the corresponding data points in each matrix pair as up regulated, down regulated, or neutral; and
(b) eliminating corresponding data points that do not provide a ratio that falls into the same category for at least half of the matrix pairs.

The method of paragraph 118 wherein there are four matrix pairs and the predetermined fraction is four out of four.

The method of paragraph 118 wherein there are four matrix pairs and the predetermined fraction is three out of four.

The method of paragraph 118 wherein there are four matrix pairs and the predetermined fraction is two out of four.

The method of paragraph 115 further comprising the step of normalizing the signal intensities of the spots within each matrix pair prior to step (e).

The method of paragraph 122 wherein the step of normalizing the signal intensities of the spots within a matrix pair comprises the steps of:
(a) ranking the data points within each data matrix of the pair according to signal intensity to generate a first and a second experimental curve showing the increase in signal intensity as a function of rank; and
(b) transforming the intensity values of the first smooth model curve into the intensity values of the second smooth model curve.

The method of paragraph 108 further comprising the step of measuring a background level for each data point in each matrix and eliminating any data points within an matrix having a background level that lies outside a predetermined number of standard deviations from the mean value of all the background measurements for the matrix.

The method of paragraph 124 wherein the predetermined number of standard deviations is two standard deviations.

The method of paragraph 118 further comprising the step of eliminating the data points that provide signal ratios that lies outside of the largest standard deviation of all of the corresponding intensity ratios multiplied by a predetermined constant.

The method of paragraph 126 wherein the constant is three.

The method of paragraph 108 wherein the first sample and the second sample comprise nucleic acids, and the signal intensity for each data point in the matrices corresponds to the relative expression level of a given gene represented in the samples.

A method for measuring the quality of a data matrix pair comprising:
(a) providing a first sample and a second sample;
(b) providing a replicate matrix pair comprising a data matrix for the first sample and a data matrix for the second sample, each data matrix comprising a plurality of data points, each data point providing a signal having an intensity, each signal corresponding to a selected property of the samples, wherein each data point in a given matrix has a corresponding data point in the other matrices, such that corresponding data points provide information about the same property of the samples;
(c) identifying and eliminating data points having signal intensities below a background noise level;
(d) identifying and eliminating any remaining data points having signals that are substantially indistinguishable from other signals in the same matrix, wherein signals are indistinguishable if they fail to meet a predetermined distinguishability criterion;
(e) ranking the remaining data points in the first matrix according to increasing signal intensity;
(f) ranking the remaining data points in the second matrix according to increasing signal intensity; and
(g) calculating a noise factor (NF) for the matrix pair according to the equation:

$$NF = \sqrt{\frac{{\sum }_{i = 1}^{n} {( {r}_{1 i} - {r}_{2 i} )}^{2}}{n}} * \frac{K}{( {r}_{max} - CR )}$$

wherein n is the total number of remaining data points in each matrix, rₘₐₓ is the rank of the highest ranking data point, r₁ᵢ is the rank of data point n in the first matrix of the pair, r₂ᵢ is the rank of the corresponding data point in the second matrix of the pair, and K is a constant.

A method for eliminating false data from a biological activity profiling experiment comprising:
(a) providing a first biological sample and a second biological sample, wherein each biological sample is labeled using at least one detectable label capable of emitting a signal having an intensity;
(b) providing at least two replicate arrays of indicator molecules;
(c) allowing the first and second biological samples to interact with the indicator molecules in the arrays;
(d) measuring the signal intensities emitted from the indicator molecules to produce at least four data matrix pairs, each matrix comprising a plurality of data points, each data point having an intensity corresponding to the level of interaction between the indicator molecules and the first and second biological samples, wherein each indicator molecule produces one data point in each of the data matrices and further wherein the data points produced by the same indicator molecule are referred to as corresponding data points;
(e) identifying and eliminating data points in each data matrix that have intensities below a background noise level;
(f) identifying and eliminating any remaining data points that are substantially indistinguishable from other data points in the same data matrix, wherein data points are indistinguishable if they fail to meet a predetermined distinguishability criterion;
(g) determining intensity ratios for the corresponding data points in the at least four matrix pairs, wherein the signal intensity ratio for each pair of corresponding data points in each matrix pair has a corresponding signal intensity ratio in each of the other matrix pairs; and
(h) identifying and eliminating any remaining data points that provide signal intensity ratios that are substantially irreproducible, wherein signal intensity ratios are substantially irreproducible if they fail to meet a predetermined reproducibility criterion.

The method of paragraph 130 wherein the first and second biological samples are selected from the group consisting of nucleic acids, cDNA, DNA, proteins, and antibodies.

The method of paragraph 130 wherein the indicator molecules are selected from the group consisting of nucleic acids, DNA, proteins, and antibodies.

The method of paragraph 130 wherein:
(a) the biological samples comprise cDNA obtained by the reverse transcription of RNA collected from two cells;
(b) the indicator molecules comprise RNA molecules laid in duplicate on a microarray slide;
(c) the samples are labeled with different detectable labels;
(d) the four data matrices are obtained by conducting reverse experiments on the two samples, such that the microarray slides each yield two images, each image comprising two duplicate data matrices for each biological sample; and
(e) the signal intensity ratios derived from the images correspond to gene expression ratios.

A method of normalizing a data matrix pair comprising:
(a) providing a first sample and a second sample;
(b) providing a data matrix pair comprising a first data matrix for the first sample and a second data matrix for the second sample, each data matrix comprising a plurality of data points, each data point providing a signal having an intensity, each signal corresponding to a selected property of the samples, wherein each data point in the first matrix has a corresponding data point in the second matrix, such that corresponding data points provide information about the same property of the samples;
(c) ranking the data points within each data matrix according to signal intensity to generate an experimental curve showing the increase in signal intensity as a function of rank; and
(d) transforming the intensity values of the first experimental curve into the intensity values of the second experimental curve.

The method of paragraph 134 wherein the first experimental curve has a higher level of noise or false data than the second experimental curve.

While preferred embodiments have been illustrated and described, it should be understood that changes and modifications can be made therein in accordance with ordinary skill in the art without departing from the invention in its broader aspects as defined in the following claims.

What is claimed is:

1. A method for eliminating indistinguishable differentials from a direct comparison of a pair of data matrices comprising a plurality of data points, wherein each data point in the first matrix of the pair has a corresponding data point in the second matrix of the pair, the method comprising:
(a) ranking the data points of each matrix from highest to lowest according to intensity such that a plot of rank versus intensity of the data points for each matrix provides an experimental curve for each matrix;
(b) fitting a smooth curve to each experimental curve to provide a model curve for each matrix, each model curve comprising a first section separated from a second section by an inflection point;
(c) eliminating any pair of corresponding data points for which each data point of the pair is below the inflection point of its model curve; and
(d) eliminating any pair of corresponding data points for which the rank of each data point of the pair is below a selected cutoff rank between rₘᵢₙ and rₘₐₓ, where rₘᵢₙ is the rank of the data point at the minimum of the derivative of one of the model curves and rₘₐₓ is the rank of the highest ranking data point on the model curve.

2. The method of claim 1, wherein each model curve has an analytical rank determined by the equation:
f′(analytical rank)=C((f(rₘₐₓ)/rₘₐₓ)),
where f′(analytical rank) is the value of the first derivative of the model curve at the analytical rank, rₘₐₓ is the rank of a data point having a rank higher than CR on the model curve, and f(rₘₐₓ) is the value of the model curve at rₘₐₓ;
and further wherein the cutoff rank is the larger analytical rank of the two model curves.

3. The method of claim 1, wherein rₘₐₓ is the rank of a data point having an intensity in the upper 30% of the model curve.

4. The method of claim 1, wherein rₘₐₓ is the rank of the highest ranking data point on the model curve.

5. The method of claim 1, further comprising normalizing the model curves by transforming the intensity values for the data points in one of the model curves to become equal to the intensity values of the data points of the same rank in the other model curve.

6. The method of claim 5, wherein the intensity values for the model curve corresponding to the less noisy data matrix are transformed to become equal to the intensity values of model curve corresponding to the noisier data matrix.

7. The method of claim 1, wherein the model curves are generated by fitting the experimental curves with the equation:
$$f ( x ) = ( \frac{{a}_{1} *}{x + {a}_{2}} + \frac{x}{{r}_{max} - x + {a}_{3}} - {a}_{4} ) * {a}_{5} * ( \frac{1}{1 + {( \frac{{a}_{7}}{x} )}^{{a}_{6}}} + \frac{{a}_{8}}{1 + {( \frac{{a}_{10}}{x} )}^{{a}_{9}}} - \frac{{a}_{11}}{x + {a}_{12}} ) * ( 1 + \frac{{a}_{13}}{1 + {\vert 1 - \frac{{a}_{15}}{x} \vert}^{{a}_{14}}} ) + ( \frac{1}{1 + {( \frac{{a}_{17}}{x} )}^{{a}_{16}}} - {a}_{18} ) * {a}_{19}$$
where x and f(x) refer to the rank and logarithmic value of the intensity at rank x, respectively, (a₁, . . . , a₁₉) are variables and rₘₐₓ is the rank of the highest ranking data point in the data matrix.

8. The method of claim 2, wherein C has a value from about 0.3 to about 0.4.

9. The method of claim 2, wherein C has a value from about 0.35 to about 0.37.

10. The method of claim 1, further comprising measuring a background level for each data points in each matrix and eliminating any pair of corresponding data point for which at least one data point of the pair has a background level that lies outside two or more standard deviations from the mean value of the background measurements for its matrix.

11. The method of claim 1, wherein each data matrix is generated from an individual sample.

12. The method of claim 1, wherein each data matrix is generated from a composite sample comprising no more than about 100 individual samples.

13. The method of claim 1, wherein the data matrices are generated from biological samples and the data points represent the expression levels of biomolecules produced by the biological samples.

14. The method of claim 1, wherein the biological samples are selected from the group consisting of cell samples, tissue samples, biological fluid samples, DNA samples and RNA samples.

15. The method of claim 1, wherein the data matrices are generated from a gene expression profiling experiment and the data points represent gene expression levels.

16. The method of claim 1, wherein the data matrices are generated from a protein expression profiling experiment and the data points represent protein expression levels.

17. The method of claim 1, wherein the data matrices are generated from a nuclei acid sequence expression profiling system and the data points represent oligonucleotide expression levels.

18. A method for eliminating false differentials from a direct comparison of three or more replicate data matrix pairs, each data matrix comprising a plurality of data points, wherein each data point in the first matrix of the pair has a corresponding data point in the second matrix of the pair and each pair of corresponding data points in each matrix pair has a corresponding pair of corresponding data points in every other matrix pair, the method comprising:
(a) eliminating indistinguishable differentials from the data matrices according to the method of claim 1;
(b) determining an intensity ratio for each remaining pair of corresponding data points in each data matrix pair, wherein each ratio is categorized as less than one, greater than one, or equal to one; and
(c) eliminating any corresponding pairs of corresponding data points for which the intensity ratios for the corresponding pairs fall into the same category for less than one half of the corresponding pairs.

19. The method of claim 18, comprising eliminating corresponding pairs of corresponding data points if the intensity ratios for the corresponding pairs fall into the same category for less than 75 percent of the corresponding pairs.

20. The method of claim 18, comprising eliminating corresponding pairs of corresponding data points if the intensity ratios for the corresponding pairs fall into the same category for less than 100 percent of the corresponding pairs.

21. The method of claim 18, further comprising eliminating any data points whose log2(intensity ratio) values lie outside the largest standard deviation of all the remaining log2(intensity ratio) values multiplied by a constant.

22. The method of claim 21, wherein the constant is at least about 2.

23. The method of claim 18, wherein the intensity ratios for the remaining data points comprise no more than 1% false differentials.

24. The method of claim 18, wherein the intensity ratios for the remaining data points comprise no more than 0.1% false differentials.

25. The method of claim 18, wherein the intensity ratios for the remaining data points comprise no more than 0.01% false differentials.

26. The method of claim 18, wherein the data matrices are generated from a gene expression profiling experiment and the intensity ratios represent gene expression ratios.

27. The method of claim 26, wherein the gene expression ratios remaining after the method is applied provide information about gene function behind a biological phenotype.

28. The method of claim 26, wherein the gene expression ratios remaining after the method is applied provide information about the genetic networks behind a biological phenotype.

29. A method for measuring the quality of a direct comparison of a pair of data matrices comprising a plurality of data points, wherein each data point in the first matrix of the pair has a corresponding data point in the second matrix of the pair, the method comprising:
(a) eliminating indistinguishable differentials from the data matrices according to the method of claim 1; and
(b) calculating a noise factor (NF) for the pair of matrices according to the equation:
$$NF = \sqrt{\frac{{\sum }_{i = 1}^{n} {( {r}_{1 i} - {r}_{2 i} )}^{2}}{n}} * \frac{K}{( {r}_{max} - CR )}$$
wherein CR is the cutoff rank, n is the total number of remaining data points whose ranks are larger than CR in both arrays, rₘₐₓ is the rank of a data point having a rank higher than CR, r₁ᵢ is the rank of data point i in the first data matrix of the pair, r₂ᵢ is the rank of the corresponding data point in the second data matrix of the pair, and K is a constant.

30. The method of claim 29, wherein rₘₐₓ is the rank of a data point having an intensity in the upper 30% of the model curve.

31. The method of claim 29, wherein rₘₐₓ is the rank of the highest ranking data point on the model curve.

32. The method of claim 29, wherein the data matrices are generated from biological samples and the data points represent the expression levels of biomolecules produced by the biological samples.

33. The method of claim 29, wherein the data matrices are generated from a gene expression profiling experiment and the intensity ratios represent gene expression ratios.

34. The method of claim 33, wherein the gene expression ratios remaining after the method is applied provide information about gene function behind a biological phenotype.

35. The method of claim 33, wherein the gene expression ratios remaining after the method is applied provide information about the genetic networks behind a biological phenotype.
